(19) United States
(12) Patent Application Publication
(10) Pub. No.: US 2014/0313794 A1
(43) Pub. Date: Oct. 23, 2014

(54) POWER DELIVERY DEVICE AND START-UP METHOD, AC ADAPTER AND ELECTRONIC APPARATUS

(71) Applicant: ROHM CO., LTD., Kyoto (JP)

(72) Inventors: Akihiro ONO, Kyoto (JP); Satoru NATE, Kyoto (JP)

(73) Assignee: ROHM CO., LTD., Kyoto (JP)

(21) Appl. No.: 14/189,277

(22) Filed: Feb. 25, 2014

(30) Foreign Application Priority Data
Feb. 25, 2013 (JP) 2013-034508

(51) Int. Cl. H02M 3/335

(52) U.S. Cl. CPC H02M 3/33523
USPC 363/21.15

(57) ABSTRACT

The PD device includes: a DC/DC converter disposed between an input and an output; a primary-side controller configured to start up the DC/DC converter; and a secondary-side controller connected to an output of the DC/DC converter, the secondary-side controller AC-coupled to the output, the secondary-side controller configured to feed back electric power information of the output to the primary-side controller and an input of the DC/DC converter, wherein the secondary-side controller controls an input current of the DC/DC converter, thereby varying an output voltage value and an available output current capacity of the DC/DC converter.

### CROSS REFERENCE TO RELATED APPLICATIONS AND INCORPORATION BY REFERENCE

This application is based upon and claims the benefit of priority from prior Japanese Patent Application No. P2013-034508 filed on Feb. 25, 2013, the entire contents of which are incorporated herein by reference.

### TECHNICAL FIELD

The present invention relates to a Power Delivery (PD) device, a start-up method for such a PD device, an AC adapter, and an electronic apparatus. The present invention relates in particular to a PD device, a start-up method for such a PD device, an AC adapter, and an electronic apparatus, each of which has a variable function of an output voltage value and an available output current capacity (MAX value).

### BACKGROUND ART

Conventionally, there have been provided Direct Current (DC) power sockets which can intercommunicate between terminal devices and power line carrier communication networks supporting telecommunications standards with a power delivery (Refer to Patent Literature 1, for example.).

There are Power over Ethernet (PoE) technology and Universal Serial Bus (USB) technology as a power delivery technology using data lines (Refer to Non Patent Literature 1, for example.).

As the USB technologies, there are USB 2.0 Standard up to maximum supply power of 2.5 W, USB 3.0 Standard up to maximum supply power of 4.5 W, and Battery Charging System (BCS) Revision 1.2 up to maximum supply power of 7.5 W according to the power delivery level.

A USB Power Delivery (USB PD) Specification Revision 1.0 is compatible with existing cables and existing connectors, and coexists also with the USB 2.0 Standard, the USB 3.0 Standard, and the USB Battery Charging System (BCS) Revision 1.2. In such a specification, values of the charging current and voltage is selectable within a range of voltage 5V-12V-20V and a range of current 1.5 A-2 A-3 A-5 A, and the USB electric charging and power transmission can be achieved to be 10 W, 18 W, 36 W, 65 W, and the maximum of 100 W.

DC/DC converters have been used as a power source for achieving such a power delivery. There are a diode rectification system and a synchronous rectification method in the DC/DC converters.

### CITATION LIST

Patent Literature 1: Japanese Patent Application Laying-Open Publication No. 2011-82802
Non-Patent Literature 1: “Special Edition: Power Delivery with Data Lines”, Nikkei Electronics, Oct. 9, 2012, pp. 23-40

### SUMMARY OF THE INVENTION

### Technical Problem

The object of the present invention is to provide a PD device, a start-up method for such a PD device, an AC adapter, and an electronic apparatus, each of which can control an output voltage value and an available output current capacity (MAX value).

### Solution to Problem

According to one aspect of the present invention, there is provided a PD device comprising: a DC/DC converter disposed between an input and an output; a primary-side controller configured to start up the DC/DC converter; a secondary-side controller connected to an output of the DC/DC converter, the secondary-side controller AC-coupled to the output, the secondary-side controller configured to feed back electric power information of the output to the primary-side controller and an input of the DC/DC converter; and an insulation circuit connected to the secondary-side controller, the insulation circuit configured to feed back the electric power information of the output to the primary-side controller, wherein the secondary-side controller controls an input current of the DC/DC converter, thereby varying an output voltage value and an available output current capacity of the DC/DC converter.

According to another aspect of the present invention, there is provided an AC Adapter comprising the above-mentioned power delivery device.

According to still another aspect of the present invention, there is provided an electronic apparatus comprising the above-mentioned power delivery device.

According to yet another aspect of the present invention, there is provided a start-up method of a power delivery device, wherein the power delivery device comprises: a DC/DC converter disposed between an input and an output; a primary-side controller configured to start up the DC/DC converter; and a secondary-side controller connected to an output of the DC/DC converter, the secondary-side controller configured to feedback electric power information of the output to the primary-side controller and an input of the DC/DC converter, wherein the method comprising: at first timing, starting up the primary-side controller; and at second timing, after an output voltage of the DC/DC converter reaches a constant level, turning off the primary-side controller, and turning on the secondary-side controller, thereby switching to control by the secondary-side controller.

### Advantageous Effects of Invention

According to the present invention, there can be provided the PD device, the start-up method for such a PD device, the AC adapter, and the electronic apparatus, each of which can control the output voltage value and the available output current capacity (MAX value).

### BRIEF DESCRIPTION OF DRAWINGS

FIG. 1 is a schematic circuit block configuration diagram showing a first Power Delivery (PD) device according to basic technology.

FIG. 2 is a schematic circuit block configuration diagram showing a second PD device according to basic technology.

FIG. 3A is a schematic diagram showing a relationship of an output voltage and an output current obtained using the second PD device according to the basic technology, which is an example of a rectangular shape showing a Constant Voltage Constant Current (CVCC).

FIG. 3B is a schematic diagram showing the relationship of the output voltage and the output current obtained using the second PD device according to the basic technology, which is an example of a fold-back shape of an inverted trapezium.

FIG. 3C is a schematic diagram showing the relationship of the output voltage and the output current obtained using the second PD device according to the basic technology, which is an example of a fold-back shape of an inverted triangle.

FIG. 3D is a schematic diagram showing the relationship of the output voltage and the output current obtained using the second PD device according to the basic technology, which is an example of a trapezoidal shape.

FIG. 3E is a schematic diagram showing the relationship of the output voltage and the output current obtained using the second PD device according to the basic technology, which is an example of a pentagon shape.

FIG. 4 is a schematic circuit block configuration diagram showing a third PD device according to the basic technology.

FIG. 5 is a schematic circuit block configuration diagram showing a fourth PD device according to the basic technology.

FIG. 6A is a schematic circuit block configuration diagram showing a PD device according to a first embodiment.

FIG. 6B is a start-up sequence diagram of a primary-side controller and a secondary-side controller in the PD device according to the first embodiment.

FIG. 6C is a schematic circuit block configuration diagram showing a PD device according to a second embodiment.

FIG. 7 is a schematic circuit block configuration diagram showing a PD device according to a third embodiment.

FIG. 8 is a schematic circuit block configuration diagram showing a PD device according to a fourth embodiment.

FIG. 9 is a schematic circuit block configuration diagram showing a PD device according to a fifth embodiment.

FIG. 10 is a schematic circuit block configuration diagram showing a PD device according to a sixth embodiment.

FIG. 11 shows a structural example of an insulating bidirectional circuit in a PD device according to a seventh embodiment.

FIG. 12 is a schematic circuit block configuration diagram showing a PD device according to an eighth embodiment.

FIG. 13A shows an example of wire connection in which a plug connectable to a power socket is connected to an AC adapter using a cable, and shows in particular an example in which a PD device in the AC adapter is connected to an external USB PD device using the cable.

FIG. 13B shows the example of wire connection in which the plug connectable to the power socket is connected to the AC adapter using the cable, and shows in particular an example in which a USB PD device is included in the AC adapter.

FIG. 13c shows the example of wire connection in which the plug connectable to the power socket is connected to the AC adapter using the cable, and shows in particular an example in which the USB PD device included in the AC adapter is connected to the external USB PD device using a USB PD cable.

FIG. 14A shows an example of wire connection in which the plug connectable to the power socket is connected to the AC adapter using a USB PD cable, and shows in particular an example in which the PD device in the AC adapter is connected to the external USB PD device using the cable.

FIG. 14B shows an example of wire connection in which the plug connectable to the power socket is connected to the AC adapter using the USB PD cable, and shows in particular an example in which a USB PD device is included in the AC adapter.

FIG. 14C shows the example of wire connection in which the plug connectable to the power socket is connected to the AC adapter using the USB PD cable, and shows in particular an example in which the USB PD device included in the AC adapter is connected to the external USB PD device using a USB PD cable.

FIG. 15A shows an example of wire connection in which the plug connectable to the power socket is included in the AC adapter, and is connected the AC adapter using the connecting means other than the cable, and shows in particular an example in which the PD device in the AC adapter is connected to the external USB PD device using the cable.

FIG. 15B shows the example of wire connection in which the plug connectable to the power socket is included in the AC adapter, and is connected the AC adapter using the connecting means other than the cable, and shows in particular an example in which the USB PD device is included in the AC adapter.

FIG. 15C shows the example of wire connection in which the plug connectable to the power socket is included in the AC adapter, and is connected the AC adapter using the connecting means other than the cable, and shows in particular an example in which the USB PD device included in the AC adapter is connected to the external USB PD device using the USB PD cable.

FIG. 16A shows an example of wire connection in which the plug connectable to the power socket is included in the AC adapter, and is connected the AC adapter using a connecting means other than the cable, having a plurality of USB ports, and shows in particular an example in which a plurality of the PD devices in the AC adapter is connected to a plurality of the external USB PD devices using the cable.

FIG. 16B shows the example of wire connection in which the plug connectable to the power socket is included in the AC adapter, and is connected the AC adapter using the connecting means other than the cable, having the plurality of the USB ports, and shows in particular an example in which the plurality of the USB PD devices is included in the AC adapter.

FIG. 16C shows the example of wire connection in which the plug connectable to the power socket is included in the AC adapter, and is connected the AC adapter using a connecting means other than the cable, having a plurality of USB ports, and shows in particular an example in which the plurality of the USB PD devices included in the AC adapter is connected to a plurality of the external USB PD device using a plurality of the USB PD cables.

FIG. 17A shows an example of wire connection in which the electronic apparatus is connected to the plug connectable to the power socket using the cable, and shows in particular an example in which a plurality of internal circuits which include the USB PD device therein are included in an electronic apparatus, having a plurality of signals using the USB PD.

FIG. 17B shows an example in which the plug connectable to the power socket is included in the electronic apparatus, the plurality of the internal circuits which include the USB PD device therein are included in the electronic apparatus, having the plurality of the signals using the USB PD.

FIG. 18A shows the example in which the plug connectable to the power socket is included in the electronic apparatus, the plurality of the internal circuits which include the USB PD device therein are included in the electronic apparatus, having the plurality of the signals using the USB PD device, and shows in particular an example in which a USB PD device connected to the outside is included in one internal circuit.

FIG. 18B shows the example in which the plug connectable to the power socket is included in the electronic apparatus, the plurality of the internal circuits which include the USB PD device therein are included in the electronic apparatus, having the plurality of the signals using the USB PD device, and shows in particular an example in which a plurality of the USB PD devices connected to the outside is included in one internal circuit.

FIG. 19A is an explanatory diagram of a protection function of the USB PD devices according to the first to eighth embodiments in the case where a smart phone is used as a connecting target.

FIG. 19B is an explanatory diagram of a protection function of the USB PD devices according to the first to eighth embodiments in the case where a laptop Personal Computer (PC) is used as a connecting target.

FIG. 20 shows a schematic bird's-eye view structure example of a plug applicable to the USB PD devices according to the first to eighth embodiments.

FIG. 21 shows a schematic bird's-eye view structure example of alternative plug applicable to the USB PD devices according to the first to eighth embodiments.

FIG. 22 shows a schematic bird's-eye view structure example of still alternative plug applicable to the USB PD devices according to the first to eighth embodiments.

FIG. 23 shows a schematic bird's-eye view structure example of yet alternative plug applicable to the USB PD devices according to the first to eighth embodiments.

FIG. 24A is a schematic block configuration diagram illustrating a USB data communication and power delivery between a battery charger system and a laptop PC, in a PD system to which the PD devices according to the first to eighth embodiments can be applied.

FIG. 24B is a schematic block configuration diagram illustrating the USB data communication and the power delivery between a smart phone and the laptop PC, in the PD system to which the PD devices according to the first to eighth embodiments can be applied.

FIG. 25A is a schematic block configuration diagram illustrating the USB data communication and the power delivery between two PCs, in the PD system to which the PD devices according to the first to eighth embodiments can be applied.

FIG. 25B is schematic diagram of a waveform in which one-directional AC information AC1 is superposed on DC power in the PD system to which the PD devices according to the first to eighth embodiments can be applied.

FIG. 25C is schematic diagram of a waveform in which reverse directional AC information AC2 is superposed on DC power in the PD system to which the PD devices according to the first to eighth embodiments can be applied.

FIG. 26A is a schematic block configuration diagram illustrating the USB data communication and the power delivery between two units, in the PD system to which the PD devices according to the first to eighth embodiments can be applied.

FIG. 26B is schematic diagram of a waveform in which bidirectional control signal is superposed on DC power in the PD system to which the PD devices according to the first to eighth embodiments can be applied.

FIG. 27 is a schematic block configuration diagram of the PD system to which the PD devices according to the first to eighth embodiments can be applied composed of an AC adapter and a smart phone each of which include the USB PD device therein.

FIG. 28 is a schematic block configuration diagram of the PD system to which the PD devices according to the first to eighth embodiments can be applied composed of two units each of which include the USB PD device therein.

FIG. 29A is a schematic block configuration diagram of the PD system to which the PD devices according to the first to eighth embodiments can be applied composed of alternative two units.

FIG. 29B is a schematic diagram illustrating a transmission direction of USB data and electric power transmitted through the USB PD cable, in the PD system to which the PD devices according to the first to eighth embodiments.

FIG. 30 is a first schematic block configuration diagram of the PD system to which the PD devices according to the first to eighth embodiments.

FIG. 31 is a second schematic block configuration diagram of the PD system to which the PD devices according to the first to eighth embodiments.

FIG. 32 is a third schematic block configuration diagram of the PD system to which the PD devices according to the first to eighth embodiments.

FIG. 33 is a fourth schematic block configuration diagram of the PD system to which the PD devices according to the first to eighth embodiments.

FIG. 34 shows a usage example of a USB PD-IC applicable to the PD devices according to the first to eighth embodiments.

FIG. 35 shows a usage example of a USB PD-IC applicable to the PD devices according to the first to eighth embodiments.

FIG. 36 shows a usage example of a USB PD-IC applicable to the PD devices according to the first to eighth embodiments.

FIG. 37 shows a usage example of a USB PD-IC applicable to the PD devices according to the first to eighth embodiments.

FIG. 38 shows a usage example of a USB PD-IC applicable to the PD devices according to the first to eighth embodiments.

### DESCRIPTION OF EMBODIMENTS

There will be described embodiments of the present invention, with reference to the drawings. In the following drawings, same blocks or elements are designated by same reference characters to eliminate redundancy and for simplicity. However, it should be known about that the drawings are schematic and are differ from an actual thing. Of course, the part from which the relation and ratio of a mutual size differ also in mutually drawings is included.

The embodiments to be described hereinafter exemplify the apparatus and method for a technical concept or spirit of the present invention; and do not specify dispositions, etc. of each component part as examples mentioned below. The embodiments of the present invention may be changed without departing from the spirit or scope of claims.

### [Basic Technology]

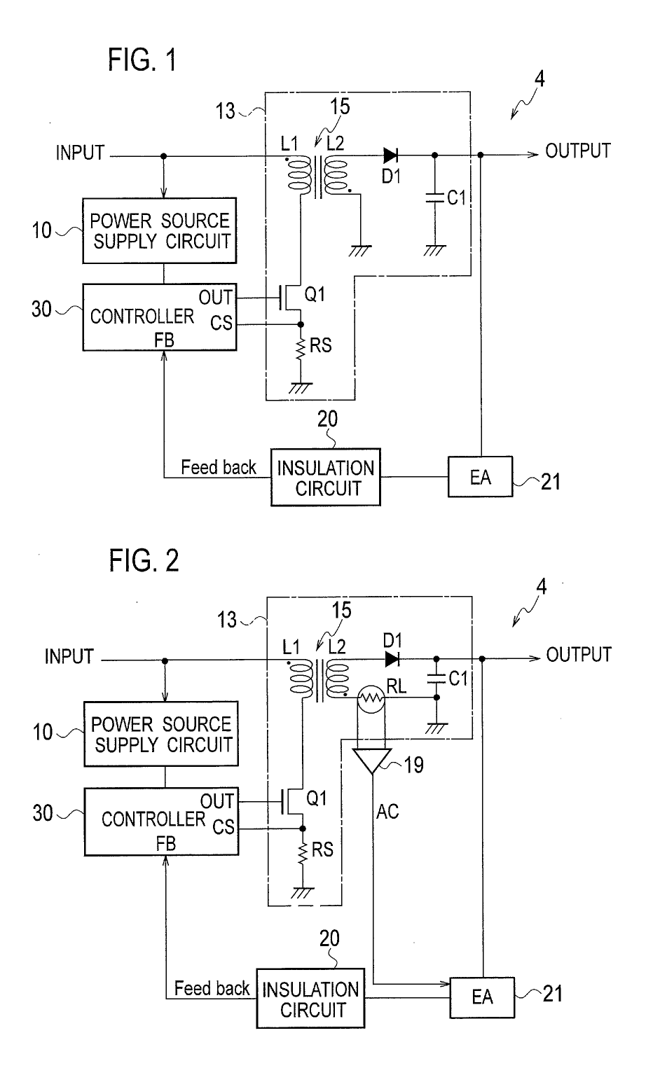

As shown in FIG. 1, a first PD device 4 according to a basic technology includes: a DC/DC converter 13 disposed between an input and an output, and composed of a transformer 15, a diode D1, a capacitor C1, and a MOS transistor Q1 connected in series between a primary-side inductance L1 of the transformer 15 and a ground potential, and a resistor RS; a primary-side controller 30 configured to control the MOS transistor Q1; a power source supply circuit 10 connected between the input and the primary-side controller 30, and configured to supply a power source to the primary-side controller 30; an error amplifier 21 for error compensation connected to the output; and an insulation circuit 20 connected to the error amplifier 21 and configured to feed back output information to the primary-side controller 30.

In the first PD device 4 according to the basic technology, the voltage is fed back from the output. More specifically, the electric power information is fed back from the output (secondary) side to the input (primary) side, and ON/OFF of MOS transistor Q1 is controlled by the primary-side controller 30, thereby stabilizing the output voltage. The amount of current conducted to the primary-side inductance L1 in the transformer 15 is detected by the current sensing resistor RS, and the amount of current of the primary-side overcurrent is controlled in the primary-side controller 30.

As shown in FIG. 2, a second PD device 4 according to the basic technology includes: a current sensing resistor RL connected to in series between a secondary-side inductance L2 of the transformer 15 and the ground potential, and a power amplifier 19 connected to the both terminals of the resistor RL. The power amplifier 19 transmits AC current information AC detected in the resistor RL to the error amplifier 21. Other configurations are the same as those of the first PD device 4 shown in FIG. 1.

According to the second PD device 4 according to the basic technology, the current sensing circuit (RL) is disposed with respect to the secondary-side inductance L2 in the transformer 15, and the amount of current in the secondary side is detected and fed back to the primary-side controller 30 through the error amplifier 21 and the insulation circuit 20. Also the a second PD device 4 according to the basic technology, the electric power information is fed back from the output (secondary) side to the input (primary) side, and ON/OFF of MOS transistor Q1 is controlled by the primary-side controller 30, thereby stabilizing the output voltage.

The second PD device 4 according to the basic technology can control the amount of current in the secondary side. Accordingly, the various relationships between the output voltage Vₒ and the output currents Iₒ can be selected in accordance with loads (e.g., smart phones, laptop PCs, tablet PCs, etc.) connected to the output.

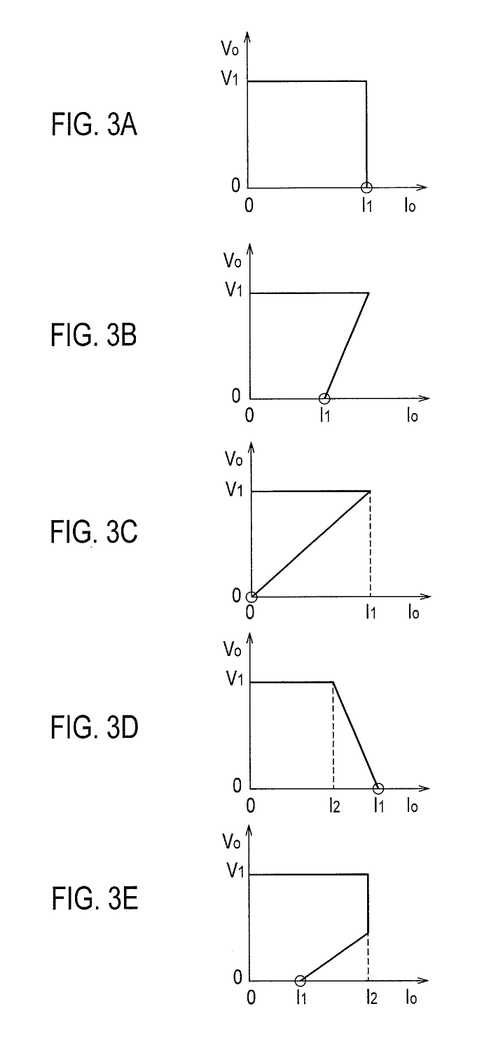

As the relationship between the output voltage Vₒ and the output current Iₒ obtained by using the second PD device 4 according to the basic technology, there can be adopted various shape, e.g. a rectangular shape as shown in FIG. 3A, a fold-back shape of inverted trapezium as shown in FIG. 3B, a fold-back shape of inverted triangle as shown in FIG. 3C, a trapezoidal shape as shown in FIG. 3D, and a pentagonal shape as shown in FIG. 3E. For example, the rectangular shape shown in FIG. 3A is an example of Constant Voltage Constant Current (CVCC).

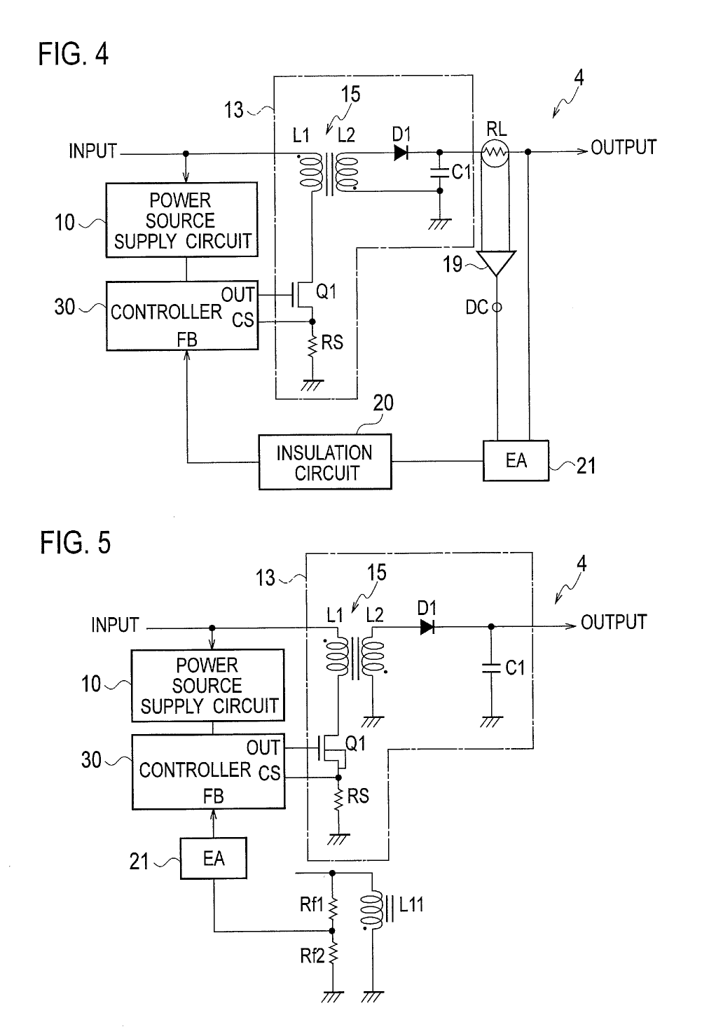

As shown in FIG. 4, a third PD device 4 according to the basic technology includes: a current sensing resistor RL connected in series between the diode D1 which composes the DC/DC converter 13, and the output, and a power amplifier 19 connected to the both terminals of the resistor RL. The power amplifier 19 can transmit DC current information to the error amplifier 21. Other configurations are the same as those of the first PD device 4 shown in FIG. 1.

The third PD device 4 according to the basic technology can also control the amount of current in the secondary side. Accordingly, as shown in FIGS. 3A, 3B, 3C, 3D and 3E, the various relationships between the output voltage Vₒ and the output currents Iₒ can be selected in accordance with loads (e.g., smart phones, laptop PCs, tablet PCs, etc.) connected to the output.

As shown in FIG. 5, a fourth PD device 4 according to the basic technology includes: an auxiliary inductance L11 composed of primary-side auxiliary winding in the transformer 15, and resistors Rf1, Rf2 for feedback connected in parallel to the auxiliary inductance L11. A detected voltage detected in the resistors Rf1, Rf2 for feedback is fed back to the primary-side controller 30 through the error amplifier 21 disposed in the primary side. Other configurations are the same as those of the first PD device 4 shown in FIG. 1.

According to the second PD device 4 according to the basic technology, the amount of power is recognized in the primary side by the auxiliary inductance L11 connected to the primary-side inductance L1 in the transformer 15 and the resistors Rf1, Rf2 for feedback, and then is fed back to the primary-side controller 30, and ON/OFF of the MOS transistor Q1 is controlled by the primary-side controller 30, thereby stabilizing the output voltage.

The second PD device 4 according to the basic technology is applicable to mobile phones, tablet PCs, etc. which can operate, for example, at approximately 10 W.

### First Embodiment

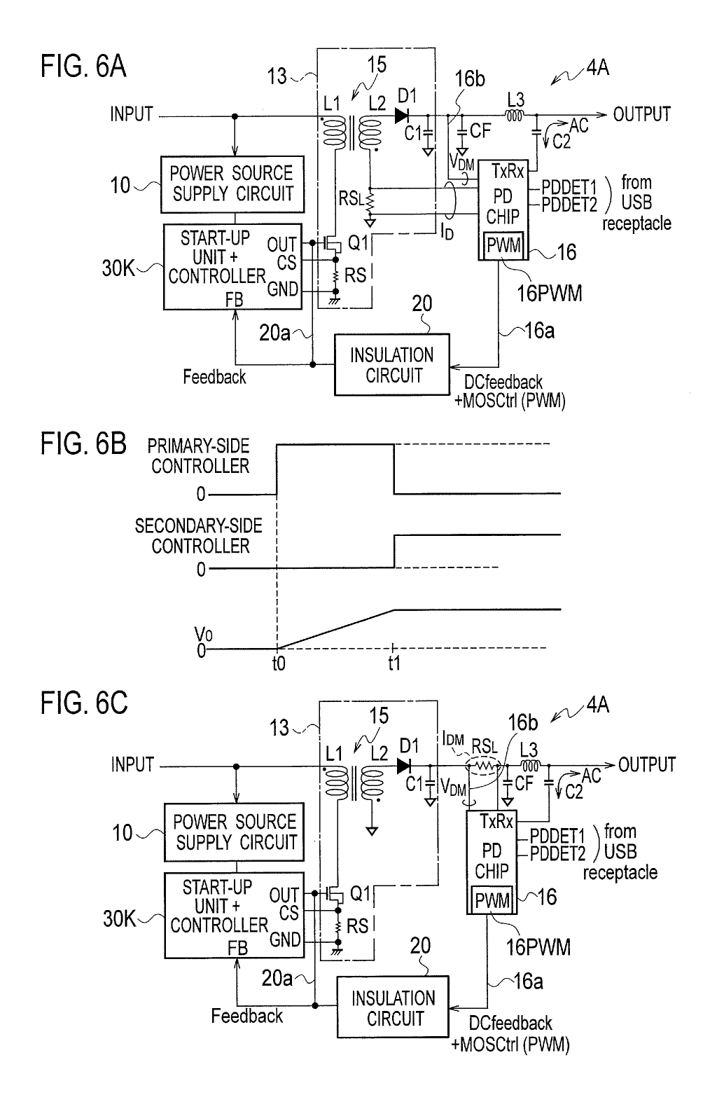

As shown in FIG. 6A, a PD device 4A according to a first embodiment includes: a DC/DC converter 13 disposed between an input and an output, and composed of a transformer 15, a diode D1, a capacitor C1, and a MOS transistor Q1 and a resistor RS connected in series between a primary-side inductance L1 of the transformer 15 and a ground potential; a primary-side controller 30K configured to control the MOS transistor Q1; a power source supply circuit 10 connected between the input and the primary-side controller 30K, and configured to supply a power source to the primary-side controller 30K; a secondary-side controller (PD CHIP) 16 which is connected to the output of the DC/DC converter 13, is connected to the output through the capacitor C2, and can control an output voltage Vₒ and an output current Iₒ; and an insulation circuit 20 connected to the secondary-side controller (PD CHIP) 16, and configured to feed back output information to the primary-side controller 30K.

In the PD device 4A according to the first embodiment, although an AC input control signal is superposed on and input into the output terminal from the outside, the AC input control signal is input into the secondary-side controller (PD CHIP) 16 through the capacitor C2 for AC coupling.

Moreover, an AC output control signal to a connecting target (setting device) connected to the output terminal can also be output to the connecting target (setting device) from the secondary-side controller (PD CHIP) 16 through the capacitor C2 for AC coupling.

The secondary-side controller 16 includes a PWM control circuit 16PWM, and thereby can transmit a driving control signal MOSCtrl (PWM) of the MOS transistor Q1 to the insulation circuit 20 through a connection line 16a between the secondary-side controller 16 and the insulation circuit 20.

The insulation circuit 20 can input the driving control signal MOSCtrl (PWM) of the MOS transistor Q1 into a gate of the MOS transistor Q1 through the connection line 20a between the insulation circuit 20 and the gates of the MOS transistor Q1.

Moreover, the secondary-side controller 16 can feed back a DC output power information of the DC/DC converter 13 through the insulation circuit 20 to the primary-side controller 30K and the input of the DC/DC converter 13.

Moreover, as shown in FIG. 6A, the PD device 4A according to the first embodiment may includes a resistor RS_{L} connected between the secondary-side inductance L2 of the transformer 15, and a ground potential. The secondary-side controller 16 can detect an amount of current I_{D} conducted to the secondary-side inductance L2 of the transformer 15 through the current sensing resistor RS_{L}, and thereby can control the amount of current, e.g. a secondary-side overcurrent.

Moreover, the secondary-side controller 16 detects and monitors an output voltage V_{DM} from the DC/DC converter 13 through the connection line 16b between the output of the DC/DC converter 13 and the secondary-side controller 16. In addition, the output voltage V_{DM} from the DC/DC converter 13 can also double as a power source of the secondary-side controller 16.

Moreover, the primary-side controller 30K can detect an amount of current conducted to the primary-side inductance L1 through the current sensing resistor RS, and thereby can control the amount of current, e.g. a primary-side overcurrent.

An inductance L3 is a separating inductance. More specifically, a filter circuit composed of the inductance L3 and a capacitor CF separates a control signal from the DC/DC converter so that the control signal from the output is not input into the DC/DC converter 13.

A capacitor, a photo coupler, a transformer, etc. is applicable to the insulation circuit 20.

In the PD device 4A according to the first embodiment, the driving control signal MOSCtrl (PWM wave) of the MOS transistor Q1 disposed in the primary side is delivered by the secondary-side controller 16. The primary-side controller 30K operates merely for start-up of the DC/DC converter 13, and the secondary-side controller 16 executes substantial output control. A start-up sequence is as being shown in FIG. 6B, in the present embodiment.

(a) At time to, the primary-side controller 30K is started up in the first place.
(b) Next, at time t1, after the output voltage Vo of the DC/DC converter 13 reaches a certain constant level (e.g., approximately 5V), the primary-side controller 30K is turned OFF, and the secondary-side controller 16 is turned ON, thereby switching to control by the secondary-side controller 16. Consequently, the secondary-side controller 16 starts a gate control of the MOS transistor Q1 disposed in the primary side.
(c) Subsequently, an output voltage value and an available output current capacity (MAX value) of the DC/DC converter 13 are controlled by the secondary-side controller 16.

As explained above, the primary-side controller 30K may merely include such a start-up circuit. More specifically, the primary-side controller 30K may merely include the configuration of such a start-up unit and such a controller (i.e., start-up unit+controller), and all the output voltage value and the available output current capacity (MAX value) of the DC/DC converter 13 are controlled by the secondary-side controller 16, thereby simplifying the circuit configuration of control system.

The PD device 4A according to the first embodiment has the variable function of the output voltage value and the available output current capacity (MAX value) by the secondary-side controller 16.

A voltage-current control circuit for controlling the output voltage Vₒ and the output current Iₒ, the PWM control circuit 16PWM for the gate control of MOS transistor Q1, etc. are built in the secondary-side controller (PD CHIP) 16.

In the PD device 4A according to the first embodiment, the variable function of the output voltage value and the available output current capacity (MAX value) of the step-down (buck) type DC/DC converter 13 is achieved by the secondary-side controller (PD CHIP) 16. Accordingly, the relationship between the output voltage Vₒ and the output currents Iₒ can be varied (variable function) in accordance with loads (e.g., smart phones, laptop PCs, tablet PCs, etc.) connected to the output.

As the relationship between the output voltage Vₒ and the output current Iₒ obtained by using the PD device 4A according to the first embodiment, there can be adopted various shape, e.g. a rectangular shape as shown in FIG. 3A, an inverted trapezoidal shape as shown in FIG. 3B, an inverted triangle shape as shown in FIG. 3C, a trapezoidal shape as shown in FIG. 3D, and a pentagonal shape as shown in FIG. 3E.

According to the first embodiment, there can be provided the PD device having the variable function of the output voltage value and the available output current capacity (MAX value) of the diode rectifying and step-down (buck) type DC/DC converter 13 achieved by the secondary-side controller (PD CHIP) 16.

In the PD device 4A according to the first embodiment, since the secondary-side controller (PD CHIP) 16 is able to USB-connect, the PD device 4A according to the first embodiment can be called a USB Power Delivery (USB PD) device.

### Second Embodiment

As shown in FIG. 6C, a PD device 4A according to a second embodiment includes a resistor RS_{L} disposed between the output of the DC/DC converter 13, and the output terminal, and the secondary-side controller 16 can detect an amount of current I_{DM} conducted between the output of the DC/DC converter 13, and the output terminal using the current sensing resistor RS_{L}. The secondary-side controller 16 can control the amount of current, e.g. a secondary-side overcurrent, on the basis of the amount of the current I_{DM}. More specifically, in the PD device 4A according to the second embodiment, the resistor RS_{L} is disposed between the output of DC/DC converter 13, and the output terminal in order to detect the amount of current after rectification by the DC/DC converter 13, instead of detecting the amount of current conducted to the secondary-side inductance L2 by the resistor RS_{L} connected between the secondary-side inductance L2 of the transformer 15, and the ground potential. Other configurations are the same as those of the first embodiment.

More specifically, the primary-side controller 30K may merely include the configuration of the start-up unit and the controller (i.e., start-up unit+controller), and all the output voltage value and the available output current capacity (MAX value) of the DC/DC converter 13 are controlled by the secondary-side controller 16, thereby simplifying the circuit configuration of control system.

Also in the PD device 4A according to the second embodiment, the variable function of the output voltage value and the available output current capacity (MAX value) of the step-down (buck) type DC/DC converter 13 is achieved by the secondary-side controller (PD CHIP) 16. Accordingly, the relationship between the output voltage Vₒ and the output currents Iₒ can be varied (variable function) in accordance with loads (e.g., smart phones, laptop PCs, tablet PCs, etc.) connected to the output.

As the relationship between the output voltage Vₒ and the output current Iₒ obtained by using the PD device 4A according to the second embodiment, there can be adopted various shape, e.g. a rectangular shape as shown in FIG. 3A, an inverted trapezoidal shape as shown in FIG. 3B, an inverted triangle shape as shown in FIG. 3C, a trapezoidal shape as shown in FIG. 3D, and a pentagonal shape as shown in FIG. 3E.

According to the second embodiment, there can be provided the PD device having the variable function of the output voltage value and the available output current capacity (MAX value) of the diode rectifying and step-down (buck) type DC/DC converter 13 achieved by the secondary-side controller (PD CHIP) 16.

Also in the PD device 4A according to the second embodiment, since the secondary-side controller (PD CHIP) 16 is able to USB-connect, the PD device 4A according to the first embodiment can be called a USB Power Delivery (USB PD) device.

### Third Embodiment

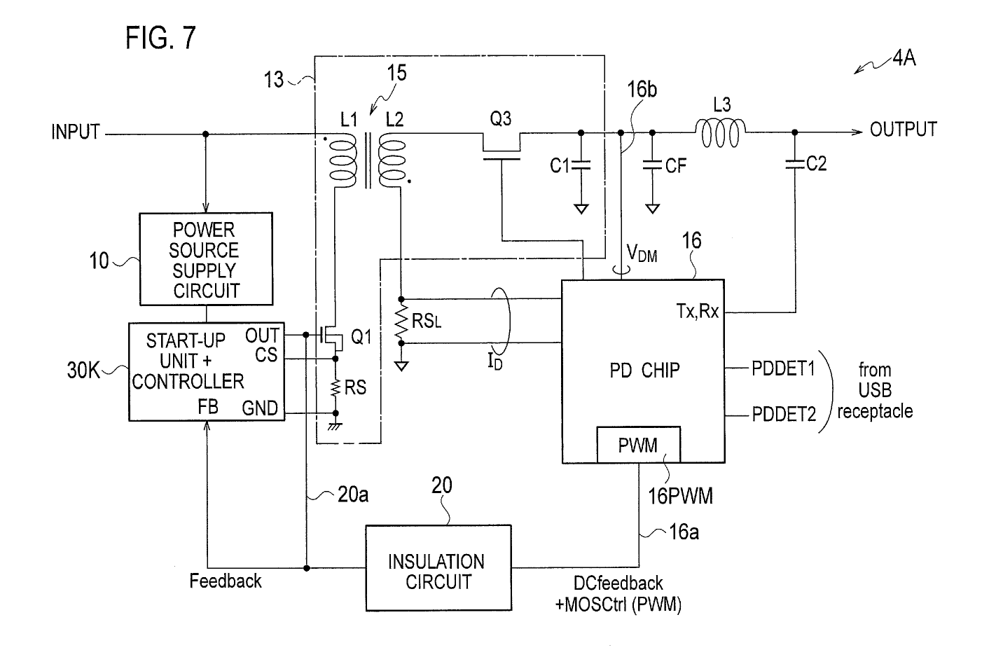

As shown in FIG. 7, a PD device 4A according to a third embodiment includes: a synchronous rectification type DC/DC converter 13 disposed between an input and an output, and composed of a transformer 15, a MOS transistor Q3, a capacitor C1, and a MOS transistor Q1 and a resistor RS connected in series between a primary-side inductance L1 of the transformer 15 and a ground potential; a primary-side controller 30K configured to control the MOS transistor Q1; a power source supply circuit 10 connected between the input and the primary-side controller 30K, and configured to supply a power source to the primary-side controller 30K; a secondary-side controller (PD CHIP) 16 which is connected to the output of the DC/DC converter 13, is connected to the output through the capacitor C2, and can control an output voltage Vₒ and an output current Iₒ; and an insulation circuit 20 connected to the secondary-side controller (PD CHIP) 16, and configured to feed back output information to the primary-side controller 30K.

In the PD device 4A according to the third embodiment, although an AC input control signal is superposed on and input into the output terminal from the outside, the AC input control signal is input into the secondary-side controller (PD CHIP) 16 through the capacitor C2 for AC coupling.

Moreover, an AC output control signal to a connecting target (setting device) connected to the output terminal can also be output to the connecting target (setting device) from the secondary-side controller (PD CHIP) 16 through the capacitor C2 for AC coupling.

The secondary-side controller 16 includes a PWM control circuit 16PWM, and thereby can transmit a driving control signal MOSCtrl (PWM) of the MOS transistor Q1 to the insulation circuit 20 through a connection line 16a between the secondary-side controller 16 and the insulation circuit 20.

The insulation circuit 20 can input the driving control signal MOSCtrl (PWM) of the MOS transistor Q1 into a gate of the MOS transistor Q1 through the connection line 20a between the insulation circuit 20 and the gates of the MOS transistor Q1.

Moreover, the secondary-side controller 16 can feed back a DC output power information of the DC/DC converter 13 through the insulation circuit 20 to the primary-side controller 30K and the input of the DC/DC converter 13.

Moreover, as shown in FIG. 7, the PD device 4A according to the third embodiment may includes a resistor R_{SL} connected between the secondary-side inductance L2 of the transformer 15, and a ground potential. The secondary-side controller 16 can detect an amount of current I_{D} conducted to the secondary-side inductance L2 of the transformer 15 through the current sensing resistor RS_{L}, and thereby can control the amount of current, e.g. a secondary-side overcurrent.

Moreover, the secondary-side controller 16 detects and monitors an output voltage V_{DM} from the DC/DC converter 13 through the connection line 16b between the output of the DC/DC converter 13 and the secondary-side controller 16. In addition, the output voltage V_{DM} from the DC/DC converter 13 can also double as a power source of the secondary-side controller 16.

Moreover, the secondary-side controller 16 is connected to the gate of MOS transistor Q3 composing the DC/DC converter 13, and can execute the switching control of the MOS transistor Q3.

Moreover, the primary-side controller 30K can detect an amount of current conducted to the primary-side inductance L1 through the current sensing resistor RS, and thereby can control the amount of current, e.g. a primary-side overcurrent.

An inductance L3 is a separating inductance. More specifically, a filter circuit composed of the inductance L3 and a capacitor CF separates a control signal from the DC/DC converter so that the control signal from the output is not input into the DC/DC converter 13.

A capacitor, a photo coupler, a transformer, etc. is applicable to the insulation circuit 20.

In the PD device 4A according to the third embodiment, the driving control signal MOSCtrl (PWM wave) of the MOS transistor Q1 disposed in the primary side is delivered by the secondary-side controller 16. The primary-side controller 30K operates merely for start-up of the DC/DC converter 13, and the secondary-side controller 16 executes a substantial output control. The start-up sequence herein is the same as that shown in FIG. 6B.

The primary-side controller 30K may merely include such a start-up circuit. More specifically, the primary-side controller 30K may merely include the configuration of such a start-up unit and such a controller (i.e., start-up unit+controller), and all the output voltage value and the available output current capacity (MAX value) of the DC/DC converter 13 are controlled by the secondary-side controller 16, thereby simplifying the circuit configuration of control system.

The PD device 4A according to the third embodiment has the variable function of the output voltage value and the available output current capacity (MAX value) by the secondary-side controller 16.

The voltage-current control circuit for controlling the output voltage Vₒ and the output current Iₒ, the PWM control circuit 16PWM for the gate control of MOS transistor Q1, etc. are built in the secondary-side controller (PD CHIP) 16.

In the PD device 4A according to the third embodiment, the variable function of the output voltage value and the available output current capacity (MAX value) of the synchronous rectification type DC/DC converter 13 is achieved by the secondary-side controller (PD CHIP) 16 to the primary-side controller 30. Accordingly, the relationship between the output voltage Vₒ and the output currents Iₒ can be varied (variable function) in accordance with loads (e.g., smart phones, laptop PCs, tablet PCs, etc.) connected to the output.

As the relationship between the output voltage Vₒ and the output current Iₒ obtained by using the PD device 4A according to the third embodiment, there can be adopted various shape, e.g. a rectangular shape as shown in FIG. 3A, an inverted trapezoidal shape as shown in FIG. 3B, an inverted triangle shape as shown in FIG. 3C, a trapezoidal shape as shown in FIG. 3D, and a pentagonal shape as shown in FIG. 3E.

In the PD device 4A according to the third embodiment, since, the synchronous rectification method is adopted for the DC/DC converter, instead of the diode rectification system, and thereby DC/DC power conversion efficiency can be increased, compared with the first to second embodiments adapting the diode rectification system.

According to the third embodiment, there can be provided the PD device having the variable function of the output voltage value and the available output current capacity (MAX value) of the synchronous rectification type and step-down (buck) type DC/DC converter 13 achieved by the secondary-side controller (PD CHIP) 16.

In the PD device 4A according to the third embodiment, since the secondary-side controller (PD CHIP) 16 is able to USB-connect, the PD device 4A according to the first embodiment can be called a USB Power Delivery (USB PD) device.

### Fourth Embodiment

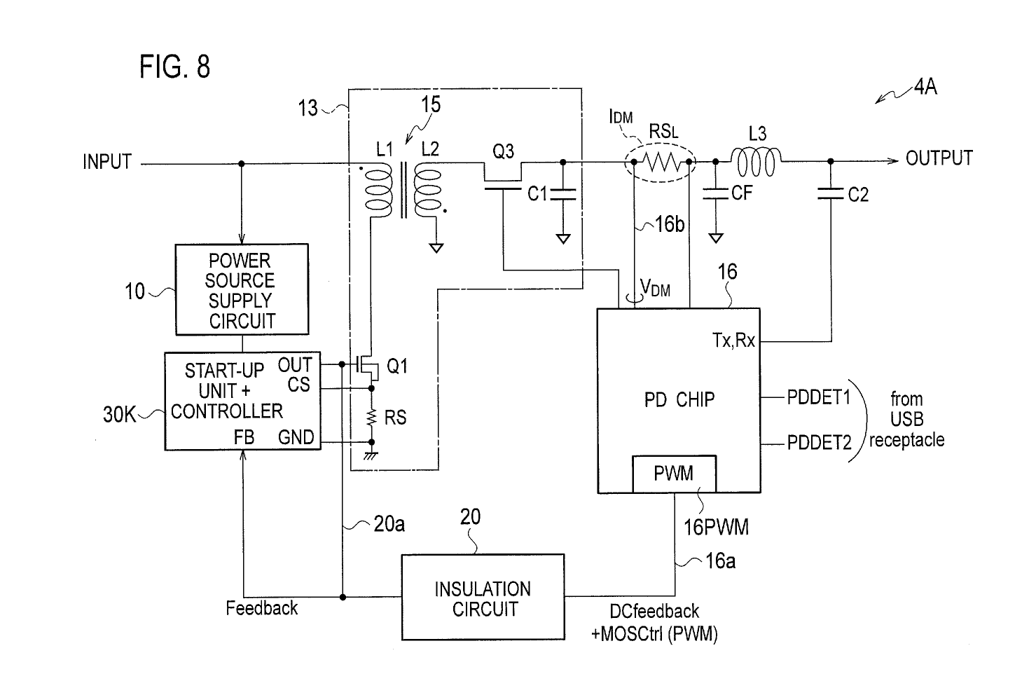

As shown in FIG. 8, a PD device 4A according to a fourth embodiment includes a resistor RS_{L} disposed between the output of DC/DC converter 13, and the output terminal, and the secondary-side controller 16 can detect an amount of current I_{DM} conducted between the output of DC/DC converter 13, and the output terminal using the current sensing resistor RS_{L}. The secondary-side controller 16 can control the amount of current, e.g. a secondary-side overcurrent, on the basis of the amount of the current I_{DM}. More specifically, in the PD device 4A according to the fourth embodiment, the resistor RS_{L} is disposed between the output of DC/DC converter 13, and the output terminal in order to detect the amount of current after rectification by the DC/DC converter 13, instead of detecting the amount of current conducted to the secondary-side inductance L2 by the resistor RS_{L} connected between the secondary-side inductance L2 of the transformer 15, and the ground potential. Other configurations are the same as those of the third embodiment.

The primary-side controller 30K may merely include the configuration of the start-up unit and the controller (i.e., start-up unit+controller), and all the output voltage value and the available output current capacity (MAX value) of the DC/DC converter 13 are controlled by the secondary-side controller 16, thereby simplifying the circuit configuration of control system.

Also in the PD device 4A according to the fourth embodiment, the variable function of the output voltage value and the available output current capacity (MAX value) of the step-down (buck) type DC/DC converter 13 is achieved by the secondary-side controller (PD CHIP) 16. Accordingly, the relationship between the output voltage Vₒ and the output currents Iₒ can be varied (variable function) in accordance with loads (e.g., smart phones, laptop PCs, tablet PCs, etc.) connected to the output.

As the relationship between the output voltage Vₒ and the output current Iₒ obtained by using the PD device 4A according to the fourth embodiment, there can be adopted various shape, e.g. a rectangular shape as shown in FIG. 3A, an inverted trapezoidal shape as shown in FIG. 3B, an inverted triangle shape as shown in FIG. 3C, a trapezoidal shape as shown in FIG. 3D, and a pentagonal shape as shown in FIG. 3E.

According to the fourth embodiment, there can be provided the PD device having the variable function of the output voltage value and the available output current capacity (MAX value) of the diode rectifying and step-down (buck) type DC/DC converter 13 achieved by the secondary-side controller (PD CHIP) 16.

Also in the PD device 4A according to the fourth embodiment, since the secondary-side controller (PD CHIP) 16 is able to USB-connect, the PD device 4A according to the first embodiment can be called a USB Power Delivery (USB PD) device.

### Fifth Embodiment

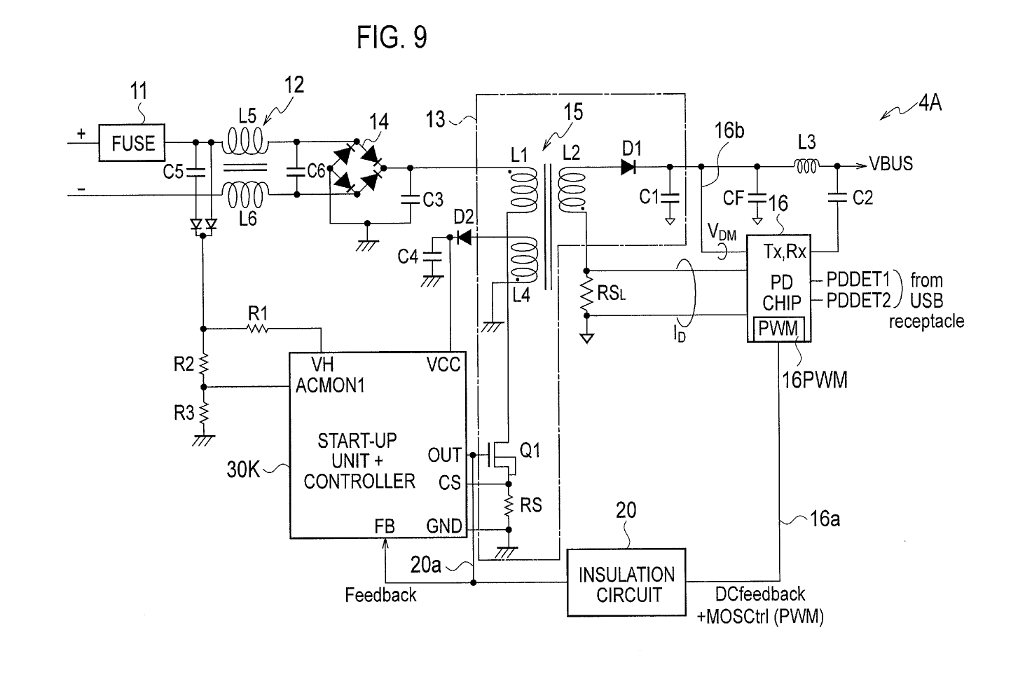

As shown in FIG. 9, a PD device 4A according to a firth embodiment includes an AC/DC converter connected to the AC input and composed of a fuse 11, a choke coil 12, a diode rectification bridge 14, capacitors C5, C6, C3, etc. instead of the power source supply circuit 10 as in the first embodiment.

Moreover, an auxiliary inductance L4 composed of the primary-side auxiliary winding in the transformer 15, and a diode D2 and a capacitor C4 connected in parallel to the auxiliary inductance L4 are provided therein, and the DC voltage VCC is supplied from the capacitor C4 to the primary-side controller 30K. Other configurations are the same as those of the first embodiment.

In the PD device 4A according to the fifth embodiment, the variable function of the output voltage value and the available output current capacity (MAX value) of the step-down (buck) type DC/DC converter 13 is achieved by the secondary-side controller (PD CHIP) 16. Accordingly, the relationship between the output voltage Vₒ and the output currents Iₒ can be varied (variable function) in accordance with loads (e.g., smart phones, laptop PCs, tablet PCs, etc.) connected to the output.

As the relationship between the output voltage Vₒ and the output current Iₒ obtained by using the PD device 4A according to the fifth embodiment, there can be adopted various shape, e.g. a rectangular shape as shown in FIG. 3A, an inverted trapezoidal shape as shown in FIG. 3B, an inverted triangle shape as shown in FIG. 3C, a trapezoidal shape as shown in FIG. 3D, and a pentagonal shape as shown in FIG. 3E.

According to the fifth embodiment, there can be provided the PD device having the variable function of the output voltage value and the available output current capacity (MAX value) of the diode rectifying and step-down (buck) type DC/DC converter 13 achieved by the secondary-side controller (PD CHIP) 16.

In the PD device 4A according to the fifth embodiment, since the secondary-side controller (PD CHIP) 16 is able to USB-connect, the PD device 4A according to the first embodiment can be called a USB Power Delivery (USB PD) device.

### Sixth Embodiment

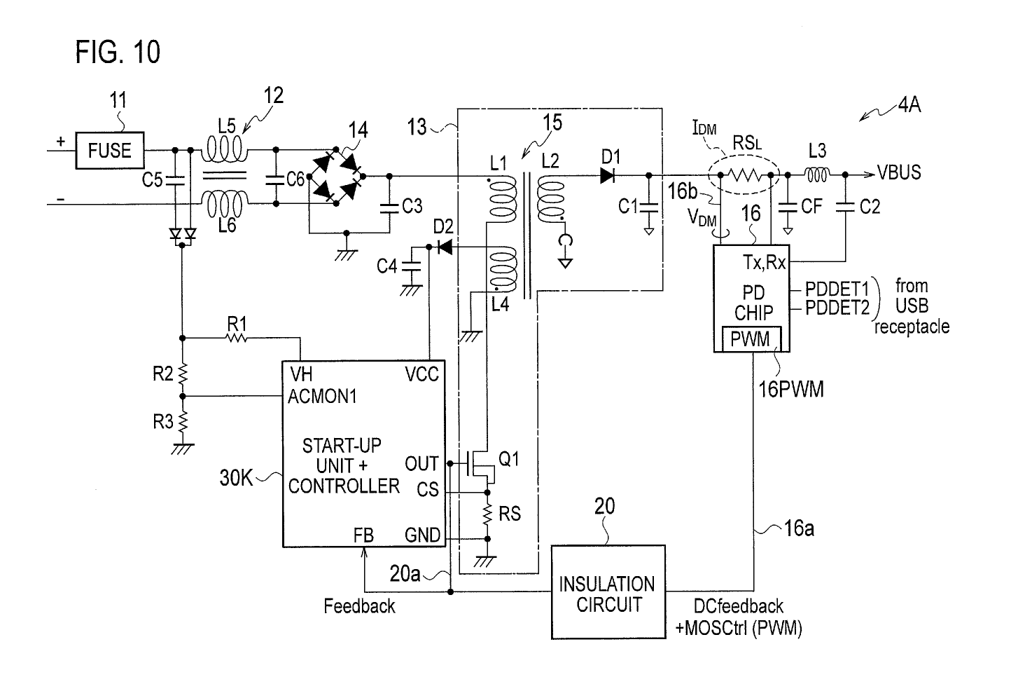

As shown in FIG. 10, a PD device 4A according to a sixth embodiment includes a resistor RS_{L} disposed between the output of DC/DC converter 13, and the output terminal, and the secondary-side controller 16 can detect an amount of current I_{DM} conducted between the output of DC/DC converter 13, and the output terminal using the current sensing resistor RS_{L}. The secondary-side controller 16 can control the amount of current, e.g. a secondary-side overcurrent, on the basis of the amount of the current I_{DM}. More specifically, in the PD device 4A according to the fifth embodiment, the resistor RS_{L} is disposed between the output of DC/DC converter 13, and the output terminal in order to detect the amount of current after rectification by the DC/DC converter 13, instead of detecting the amount of current conducted to the secondary-side inductance L2 by the resistor RS_{L} connected between the secondary-side inductance L2 of the transformer 15, and the ground potential. Other configurations are the same as those of the fifth embodiment.

The primary-side controller 30K may merely include the configuration of the start-up unit and the controller (i.e., start-up unit+controller), and all the output voltage value and the available output current capacity (MAX value) of the DC/DC converter 13 are controlled by the secondary-side controller 16, thereby simplifying the circuit configuration of control system.

Also in the PD device 4A according to the sixth embodiment, the variable function of the output voltage value and the available output current capacity (MAX value) of the step-down (buck) type DC/DC converter 13 is achieved by the secondary-side controller (PD CHIP) 16. Accordingly, the relationship between the output voltage Vₒ and the output currents Iₒ can be varied (variable function) in accordance with loads (e.g., smart phones, laptop PCs, tablet PCs, etc.) connected to the output.

As the relationship between the output voltage Vₒ and the output current Iₒ obtained by using the PD device 4A according to the sixth embodiment, there can be adopted various shape, e.g. a rectangular shape as shown in FIG. 3A, an inverted trapezoidal shape as shown in FIG. 3B, an inverted triangle shape as shown in FIG. 3C, a trapezoidal shape as shown in FIG. 3D, and a pentagonal shape as shown in FIG. 3E.

According to the sixth embodiment, there can be provided the PD device having the variable function of the output voltage value and the available output current capacity (MAX value) of the diode rectifying and step-down (buck) type DC/DC converter 13 achieved by the secondary-side controller (PD CHIP) 16.

Also in the PD device 4A according to the sixth embodiment, since the secondary-side controller (PD CHIP) 16 is able to USB-connect, the PD device 4A according to the first embodiment can be called a USB Power Delivery (USB PD) device.

### Seventh Embodiment

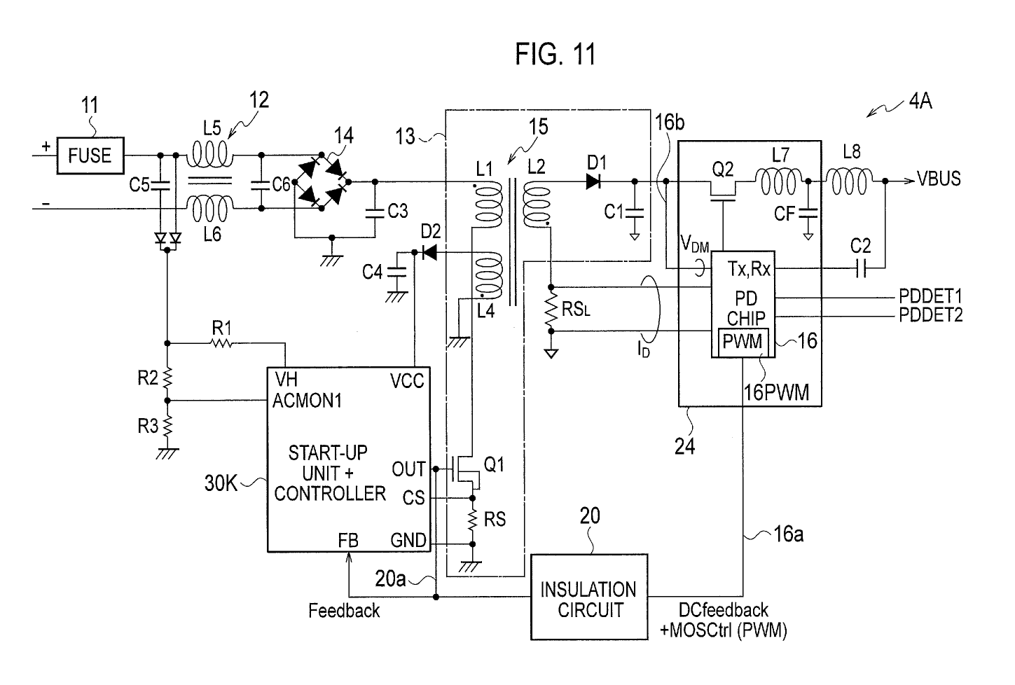

As shown in FIG. 11, an AC/DC converter connected to the AC input and composed of a fuse 11, a choke coil 12, a diode rectification bridge 14, capacitors C5, C6, C3, etc. instead of the power source supply circuit 10 as in the fifth embodiment, in the same manner as the third embodiment.

As shown in FIG. 11, a PD device 4A according to an seventh embodiment includes an independent DC/DC converter 24 which is connected to the output of the step-down (buck) type DC/DC converter 13 and which includes the secondary-side controller (PD CHIP) 16 therein.

The synchronous rectification type DC/DC converter 24 is composed of the MOS transistor Q2, the inductance L7, and the secondary-side controller (PD CHIP) 16. The secondary-side controller (PD CHIP) 16 is connected to the gate of the MOS transistor Q2, and the secondary-side controller (PD CHIP) 16 controls ON/OFF of the MOS transistor Q2. The inductance L7 is an inductance used for the DC/DC converter 24.

An inductance L8 is a PD separating inductance. More specifically, a filter circuit composed of the inductance L8 and a capacitor C5 separates a control signal from the DC/DC converter so that the control signal from the output side is not input into the DC/DC converter.

As shown in FIG. 11, a PD device 4A according to a seventh embodiment includes: a DC/DC converter 13 disposed between an input and an output, and composed of a transformer 15, a diode D1, a capacitor C1, and a MOS transistor Q1 and a resistor RS connected in series between a primary-side inductance L1 of the transformer 15 and a ground potential; a primary-side controller 30K configured to control the MOS transistor Q1; a secondary-side controller (PD CHIP) 16 which is connected to the output of the DC/DC converter 13, is connected to the output through the capacitor C2, and can control an output voltage Vₒ and an output current Iₒ; and an insulation circuit 20 connected to the secondary-side controller (PD CHIP) 16, and configured to feed back output information to the primary-side controller 30K.

In the PD device 4A according to the seventh embodiment, although an AC input control signal is superposed on and input into the output terminal from the outside, the AC input control signal is input into the secondary-side controller (PD CHIP) 16 through the capacitor C2 for AC coupling.

Moreover, an AC output control signal to a connecting target (setting device) connected to the output terminal can also be output to the connecting target (setting device) from the secondary-side controller (PD CHIP) 16 through the capacitor C2 for AC coupling.

The secondary-side controller 16 includes a PWM control circuit 16PWM, and thereby can transmit a driving control signal MOSCtrl (PWM) of the MOS transistor Q1 to the insulation circuit 20 through a connection line 16a between the secondary-side controller 16 and the insulation circuit 20.

The insulation circuit 20 can input the driving control signal MOSCtrl (PWM) of the MOS transistor Q1 into a gate of the MOS transistor Q1 through the connection line 20a between the insulation circuit 20 and the gates of the MOS transistor Q1.

Moreover, the secondary-side controller 16 can feed back a DC output power information of the DC/DC converter 13 through the insulation circuit 20 to the primary-side controller 30K and the input of the DC/DC converter 13.

Moreover, as shown in FIG. 11, the PD device 4A according to the seventh embodiment may includes a resistor RS_{L} connected between the secondary-side inductance L2 of the transformer 15, and a ground potential. The secondary-side controller 16 can detect an amount of current I_{D} conducted to the secondary-side inductance L2 of the transformer 15 through the current sensing resistor RS_{L}, and thereby can control amount of current, e.g. a secondary-side overcurrent.

Moreover, the secondary-side controller 16 detects and monitors an output voltage V_{DM} from the DC/DC converter 13 through the connection line 16b between the output of the DC/DC converter 13 and the secondary-side controller 16. In addition, the output voltage V_{DM} from the DC/DC converter 13 can also double as a power source of the secondary-side controller 16.

Moreover, the primary-side controller 30K can detect an amount of current conducted to the primary-side inductance L1 through the current sensing resistor RS, and thereby can control the amount of current, e.g. a primary-side overcurrent.

A capacitor, a photo coupler, a transformer, etc. is applicable to the insulation circuit 20.

In the PD device 4A according to the seventh embodiment, the driving control signal MOSCtrl (PWM wave) of the MOS transistor Q1 disposed in the primary side is delivered by the secondary-side controller 16. The primary-side controller 30K operates merely for start-up of the DC/DC converter 13, and the secondary-side controller 16 executes a substantial output control. The start-up sequence herein is the same as that shown in FIG. 6B.

The primary-side controller 30K may merely include such a start-up circuit. More specifically, the primary-side controller 30K may merely include the configuration of such a start-up unit and such a controller, and all the output voltage value and the available output current capacity (MAX value) of the DC/DC converter 13 are controlled by the secondary-side controller 16, thereby simplifying the circuit configuration of control system.

The PD device 4A according to the seventh embodiment also has the variable function of the output voltage value and the available output current capacity (MAX value) by the secondary-side controller 16.

A voltage-current control circuit for controlling the output voltage Vₒ and the output current Iₒ, the PWM control circuit 16PWM for the gate control of MOS transistor Q1, etc. are built in the secondary-side controller (PD CHIP) 16.

In the PD device 4A according to the seventh embodiment, the variable function of the output voltage value and the available output current capacity (MAX value) of the step-down (buck) type DC/DC converter 13 is achieved by the secondary-side controller (PD CHIP) 16 built in the synchronous rectification type DC/DC converter 24. Accordingly, the relationship between the output voltage Vₒ and the output currents Iₒ can be varied (variable function) in accordance with loads (e.g., smart phones, laptop PCs, tablet PCs, etc.) connected to the output.

As the relationship between the output voltage Vₒ and the output current Iₒ obtained by using the PD device 4A according to the seventh embodiment, there can be adopted various shape, e.g. a rectangular shape as shown in FIG. 3A, an inverted trapezoidal shape as shown in FIG. 3B, an inverted triangle shape as shown in FIG. 3C, a trapezoidal shape as shown in FIG. 3D, and a pentagonal shape as shown in FIG. 3E.

According to the seventh embodiment, there can be provided the PD device having the variable function of the output voltage value and the available output current capacity (MAX value) of the diode rectifying and step-down (buck) type DC/DC converter 13 achieved by the secondary-side controller (PD CHIP) 16 built in the synchronous rectification type DC/DC converter 24.

In the PD device 4A according to the seventh embodiment, since the secondary-side controller (PD CHIP) 16 is able to USB-connect, the PD device 4A according to the third embodiment can be called a USB Power Delivery (USB PD) device having the AC/DC converter function (AC/DC+USB PD).

### Eighth Embodiment

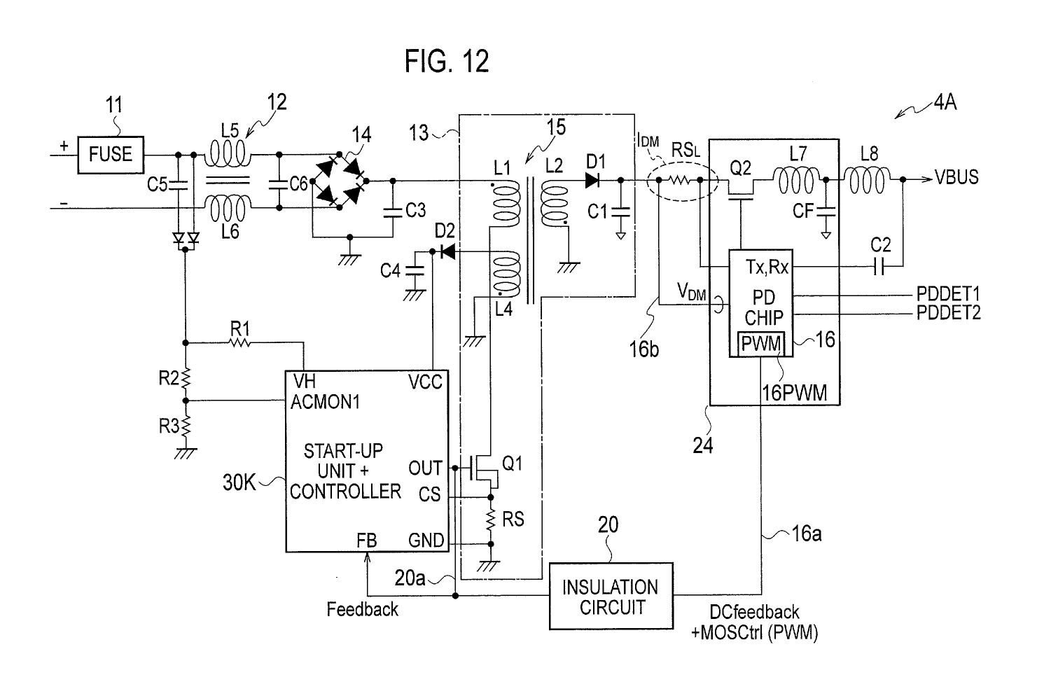

As shown in FIG. 12, a PD device 4A according to an eighth embodiment includes a resistor RS_{L} disposed between the output of DC/DC converter 13, and the output terminal, and the secondary-side controller 16 can detect an amount of current I_{DM} conducted between the output of DC/DC converter 13, and the output terminal using the current sensing resistor RS_{L}. The secondary-side controller 16 can control the amount of current, e.g. a secondary-side overcurrent, on the basis of the amount of the current I_{DM}. More specifically, in the PD device 4A according to the eighth embodiment, the resistor RS_{L} is disposed between the output of DC/DC converter 13, and the output terminal in order to detect the amount of current after rectification by the DC/DC converter 13, instead of detecting the amount of current conducted to the secondary-side inductance L2 by the resistor RS_{L} connected between the secondary-side inductance L2 of the transformer 15, and the ground potential. Other configurations are the same as those of the seventh embodiment.

The primary-side controller 30K may merely include the configuration of the start-up unit and the controller (i.e., start-up unit+controller), and all the output voltage value and the available output current capacity (MAX value) of the DC/DC converter 13 are controlled by the secondary-side controller 16, thereby simplifying the circuit configuration of control system.

Also in the PD device 4A according to the eighth embodiment, the variable function of the output voltage value and the available output current capacity (MAX value) of the step-down (buck) type DC/DC converter 13 is achieved by the secondary-side controller (PD CHIP) 16. Accordingly, the relationship between the output voltage Vₒ and the output currents Iₒ can be varied (variable function) in accordance with loads (e.g., smart phones, laptop PCs, tablet PCs, etc.) connected to the output.

As the relationship between the output voltage Vₒ and the output current Iₒ obtained by using the PD device 4A according to the eighth embodiment, there can be adopted various shape, e.g. a rectangular shape as shown in FIG. 3A, an inverted trapezoidal shape as shown in FIG. 3B, an inverted triangle shape as shown in FIG. 3C, a trapezoidal shape as shown in FIG. 3D, and a pentagonal shape as shown in FIG. 3E.

According to the eighth embodiment, there can be provided the PD device having the variable function of the output voltage value and the available output current capacity (MAX value) of the diode rectifying and step-down (buck) type DC/DC converter 13 achieved by the secondary-side controller (PD CHIP) 16.

Also in the PD device 4A according to the eighth embodiment, since the secondary-side controller (PD CHIP) 16 is able to USB-connect, the PD device 4A according to the third embodiment can be called a USB Power Delivery (USB PD) device having the AC/DC converter function (AC/DC+USB PD).

### (AC Adapter)

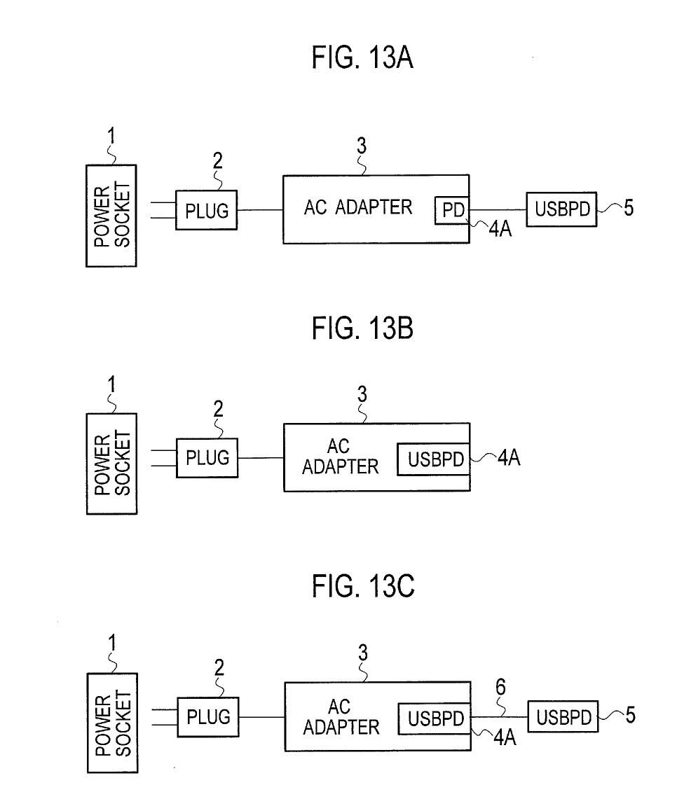

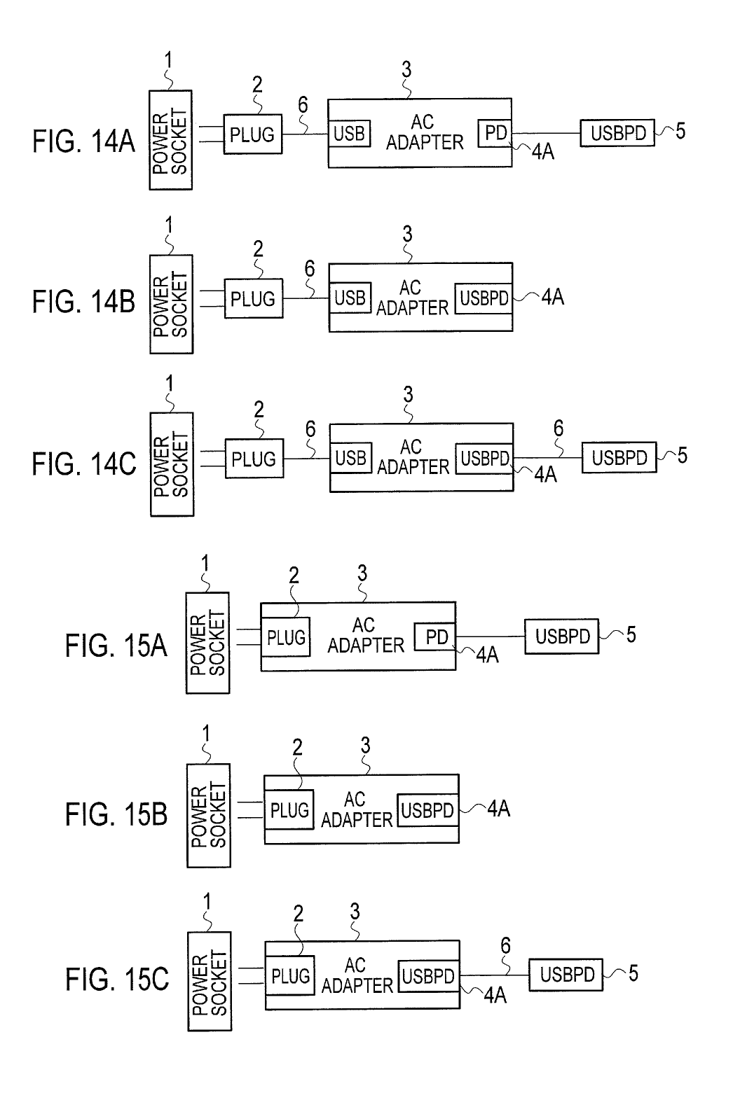

The PD device 4A according to the first to eighth embodiments can be included in an AC adapter 3, as shown in FIGS. 13A-13C and 14A-14C. Moreover, the AC adapter 3 can be connected to the USB PD device 5 disposed in the outside according to the first to eighth embodiments with a cable, or a USB PD cable 6.

The AC adapter 3 including the PD device 4A according to the first to eighth embodiments can be connected to both of a plug 2 connectable to a power socket 1 and the USB PD device 5 disposed on the outside, using the cable, as shown in FIG. 13A.

Moreover, the AC adapter 3 including the USB PD device 4A according to the first to eighth embodiments can be connected to the plug 2 connectable to the power socket 1 using the cable, as shown in FIG. 13B.

Moreover, the AC adapter 3 including the PD device 4A according to the first to eighth embodiments can be connected to both of the plug 2 connectable to the power socket 1 and the USB PD device 5 disposed in the outside, using the USB PD cable 6, as shown in FIG. 13C.

Moreover, as shown in FIG. 14A, the AC adapter 3 including the PD device 4A according to the first to eighth embodiments can be connected to the plug 2 connectable to the power socket 1 using the USB PD cable 6; and can be connected to the USB PD device 5 disposed on the outside using the cable.

Moreover, the AC adapter 3 including the PD device 4A according to the first to eighth embodiments can be connected to the plug 2 connectable to the power socket 1 using the USB PD cable 6, as shown in FIG. 14B.

Moreover, as shown in FIG. 14C, the AC adapter 3 including the USB PD device 4A according to the first to eighth embodiments can be connected to the plug 2 connectable to the power socket 1 using the USB PD cable 6; and can be connected to the USB PD device 5 disposed on the outside using the USB PD cable.

Moreover, the plug 2 connectable to the power socket 1 may be included in the AC adapter 3 including the PD device 4A according to the first to eighth embodiments, as shown in FIGS. 15A, 15B and 15C.

The AC adapter 3 including the PD device 4A according to the first to eighth embodiments and the plug 2 connectable to the power socket 1 can be connected to the USB PD device 5 disposed on the outside using the cable, as shown in FIG. 15A.

Moreover, the AC adapter 3 including the USB PD device 4A according to the first to eighth embodiments and the plug 2 connectable to the power socket 1 is illustrated as shown in FIG. 15B.

Moreover, as shown in FIG. 15C, the AC adapter 3 including the USB PD device 4A according to the first to eighth embodiments and the plug 2 connectable to the power socket 1 can be connected to the USB PD device 5 disposed on the outside using the USB PD cable 6.

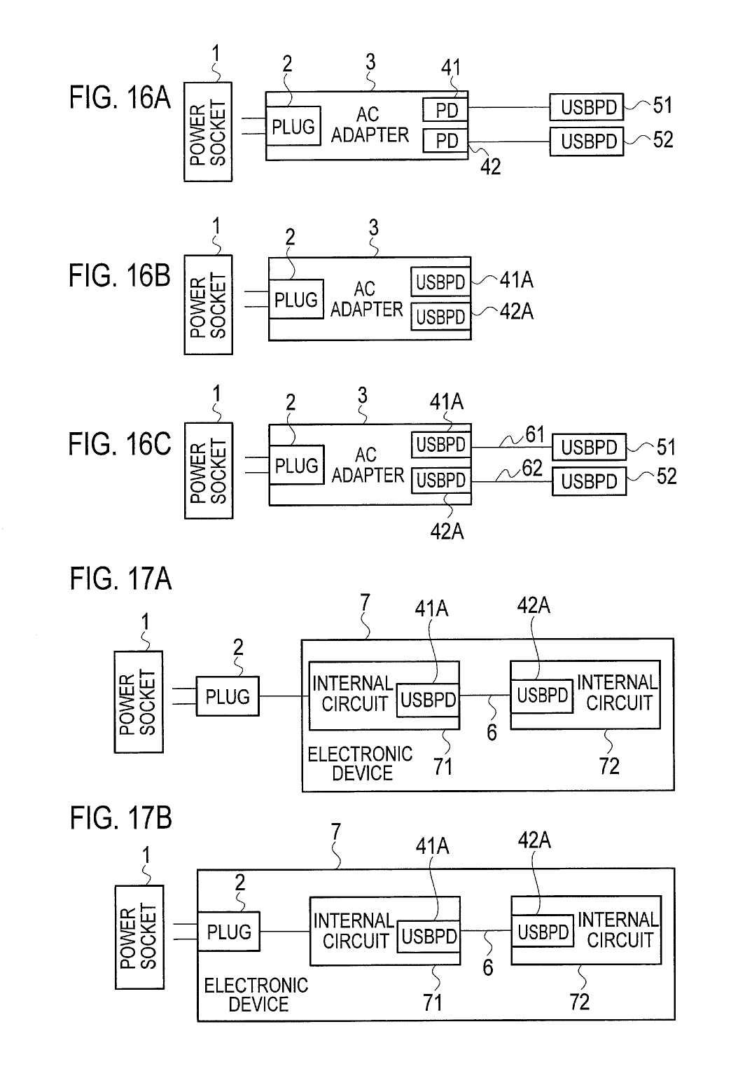

A plurality of the PD devices 4A according to the first to eighth embodiments can be included in the AC adapter 3, as shown in FIGS. 16A, 16B and 16C. Moreover, the PD devices 4A can be connected to the USB PD devices 51, 52 disposed in the outside according to the first to eighth embodiments with the cable or the USB PD cables 61, 62.

As shown in FIG. 16A, the AC adapter 3 including the USB PD devices 41, 42 according to the first to eighth embodiments and the plug 2 connectable to the power socket 1 can be connected to the USB PD devices 51, 52 disposed on the outside using the cable.

Moreover, the AC adapter 3 including the USB PD devices 41A, 42A according to the first to eighth embodiments and the plug 2 connectable to the power socket 1 is illustrated as shown in FIG. 16B.

Moreover, as shown in FIG. 16C, the AC adapter 3 including the USB PD devices 41A, 42A according to the first to eighth embodiments and the plug 2 connectable to the power socket 1 can be connected to the USB PD devices 51, 52 disposed on the outside using the USB PD cables 61, 62.

In addition, in the configuration of FIGS. 16A, 16B and 16C, the plug 2 which can be connected to the power socket 1 may have a plug shape as disposed on the outside of the AC adapter 3 in the same manner as the configuration of FIG. 13 or 14.

### (Electronic Device)

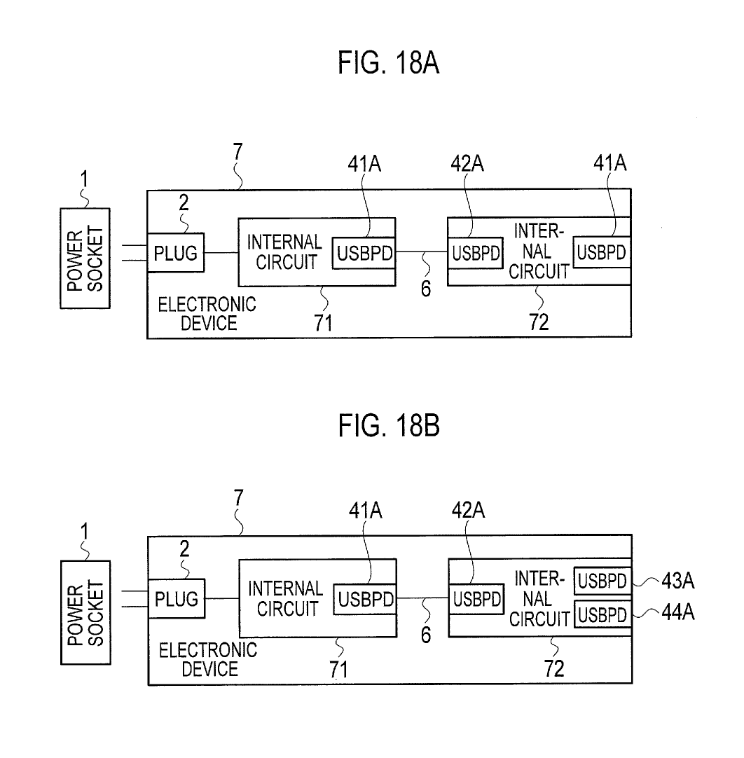

The PD devices 41A, 42A according to the first to eighth embodiments can be included in an electronic apparatus 7, as shown in FIGS. 17A, 17B, 18A and 18B. Various devices, e.g. smart phones, laptop PCs, tablet PCs, monitors or TVs, external hard disk drives, set top boxes, cleaners, refrigerators, washing machines, telephone sets, facsimile machines, printers, laser displays, are applicable to the electronic apparatus, for example.

The electronic apparatus 7 including the PD devices 41A, 42A according to the first to eighth embodiments is connected to the plug 2 connectable to the power socket 1 using the cable, as shown in FIG. 17A.

Moreover, the electronic apparatus 7 may include the plug 2 connectable to the power socket 1 in the electronic apparatus 7, as shown in FIG. 17B.

As shown in FIGS. 17A and 17B, the electronic apparatus 7 includes a plurality of internal circuits 71, 72 respectively including the USB PD devices 41A, 42A according to the first to eighth embodiments, and the USB PD devices 41A, 42A are connected to each other using the USB PD cable 6. Since the electronic apparatus 7 includes the plurality of the internal circuits 71, 72 including the USB PD devices 41A, 42A, there are a plurality of signals used for the USB PD devices 41A, 42A in the electronic apparatus 7.

The electronic apparatus 7 including the PD devices 41A, 42A according to the first to eighth embodiments may include the USB PD device 41 connectable to other electronic apparatus disposed in the outside of electronic apparatus 7, in one internal circuit 72, as shown in FIG. 18A.

As shown in FIG. 18B, the electronic apparatus 7 including the PD devices 41A, 42A according to the first to eighth embodiments may include a plurality of the USB PD devices 43A, 44A connectable to other electronic apparatus disposed in the outside of electronic apparatus 7, in one internal circuit 72, as shown in FIG. 18A.

In the configuration shown in FIGS. 13-18, each the USB PD 4A 41, 42, 41A, 42A, 43A and 44A denotes a receptacle (socket) of the USB PD, and each the USB PD 5, 51 and 52 denotes a plug of the USB PD.

### (Protection Function)

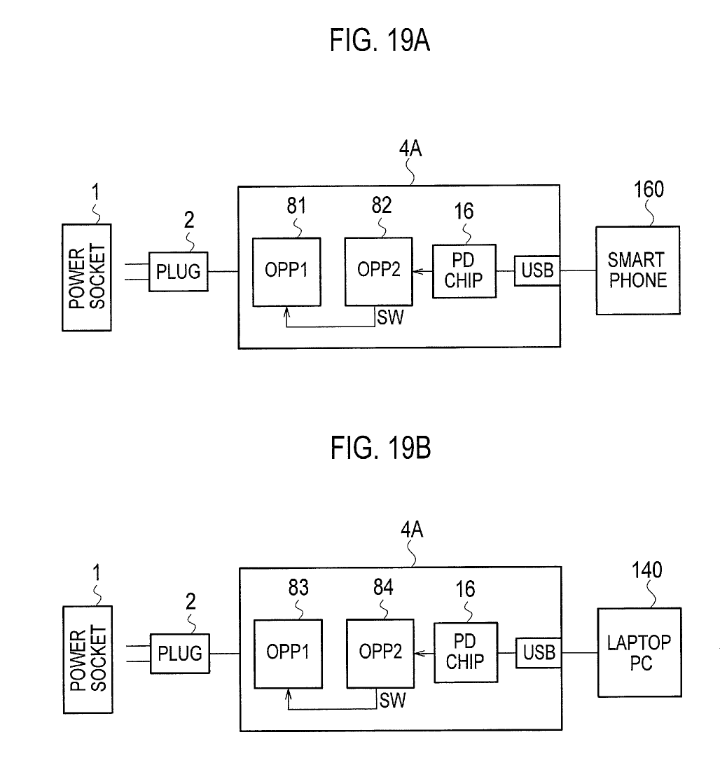

As shown in FIG. 19A, the PD device 4A according to the first to eighth embodiments may include: a primary-side OverPower Protecting circuit (OPP1) 81; and a secondary-side OverPower Protecting circuit (OPP2) 82 connected to the primary-side overpower protecting circuit (OPP1) 81.

The primary-side overpower protecting circuit (OPP1) 81 is connected to the primary-side controller 30K. Moreover, the primary-side overpower protecting circuit (OPP1) 81 may be included in the primary-side controller 30K.

The secondary-side overpower protecting circuit (OPP2) 82 is connected to the secondary-side controller (PD CHIP) 16.

In FIG. 19A, although the AC/DC converter, the DC/DC converter 13, etc. are not illustrated, the configuration of the PD device 4A according to the first to eighth embodiments as shown in FIGS. 6-12 can be applied thereto.

In accordance with target equipments (sets) connected to the USB connector, the electric power information in the USB connector is transmitted to the secondary-side overpower protecting circuit (OPP2) 82 from the secondary-side controller (PD CHIP) 16, and the secondary-side overpower protecting circuit (OPP2) 82 communicates the electric power information in the output terminal to the primary-side overpower protecting circuit (OPP1) 81.

Consequently, an overcurrent detecting set value can be changed in accordance with the target equipments (sets) connected to the USB connector, thereby executing power change of the DC/DC converter 13.

Any of the primary-side overpower protecting circuit (OPP1) 81 and the secondary-side overpower protecting circuit (OPP2) 82 may determine whether the electric power information in the USB connector exceeds the overcurrent detecting set value.

If any one of the primary-side overpower protecting circuit (OPP1) 81 and the secondary-side overpower protecting circuit 82 (OPP2) determines that the electric power information in the USB connector exceeds the overcurrent (overpower) detecting set value, the primary-side overpower protecting circuit (OPP1) 81 can transmit the overcurrent (overpower) protecting control signal to the primary-side controller 30K, thereby executing the change for controlling the electric power in the DC/DC converter 13.

There are applicable functions, e.g. an OverCurrent Protection (OCP), an OverPower Protection (OPP), OverVoltage Protection (OVP), OverLoad Protection (OLP), and a Thermal Shut Down (TSD), to the PD device 4A according to the first to eighth embodiments.

The PD device 4A according to the first to eighth embodiments includes a sensor (SENSOR) protection function for executing protection corresponding to the characteristics of a certain sensor element connected to the primary-side controller 30K, for example.

When changing the overcurrent (overpower) detecting set value in the PD device 4A according to the first to eighth embodiments, as mentioned above, the electric power information in the USB connector is transmitted to the primary-side overpower protecting circuit (OPP1) 81 through the secondary-side controller (PD CHIP) 16 and the secondary-side overpower protecting circuit (OPP2) 82, and the overcurrent detecting set value is changed corresponding to the target equipments (sets) connected to the USB connector, thereby executing the power change of the DC/DC converter 13.

Moreover, when changing the overcurrent (overpower) detecting set value in the PD device 4A according to the first to eighth embodiments, the electric power information in the USB connector may be directly transmitted to the primary-side overpower protecting circuit (OPP1) 81 from the secondary-side controller (PD CHIP) 16, and then the set value may be directly changed in the primary-side overpower protecting circuit (OPP1) 81.

Moreover, the electric power information may be directly transmitted to the primary-side overpower protecting circuit (OPP1) 81 from the PD device disposed in the outside of the PD device 4A according to the first to eighth embodiments.

Thus, according to the PD device 4A according to the first to eighth embodiments, it is possible to change the power delivery level in accordance with the target equipments (sets) connected to the USB connector, in the primary-side overpower protecting circuit (OPP1) 81. Consequently, a destruction of the target equipments (sets) can be prevented under an abnormal state.

When using a smart phone 160 as a connecting target, if the electric power information of 7 W is transmitted to the secondary-side overpower protecting circuit (OPP2) 82 from the secondary-side controller (PD CHIP) 16, for example, with respect to the smart phone 160 (the amount of power 5V·1 A=5 W), the electric power information of 7 W is transmitted to the primary-side overpower protecting circuit (OPP1) 81 from the secondary-side overpower protecting circuit (OPP2) 82, and then the overcurrent (overpower) detecting set value is changed (SW) from 7 W up to 10 W in the primary-side overpower protecting circuit (OPP1) 81. Consequently, the electric power up to 10 W can be transmitted, in the DC/DC converter in the PD device 4A according to the first to eighth embodiments.

When using a laptop PC 140 as a connecting target, if the electric power information of 80 W is transmitted to the secondary-side overpower protecting circuit (OPP2) 82 from the secondary-side controller (PD CHIP) 16, for example, with respect to the laptop PC 140 (the amount of power 20V·3 A=60 W), the electric power information of 80 W is transmitted to the primary-side overpower protecting circuit (OPP1) 81 from the secondary-side overpower protecting circuit (OPP2) 82, and then the overcurrent (overpower) detecting set value is changed (SW) from 80 W up to 100 W in the primary-side overpower protecting circuit (OPP1) 81. Consequently, the electric power up to 100 W can be transmitted, in the DC/DC converter in the PD device 4A according to the first to eighth embodiments.

### (Plug)

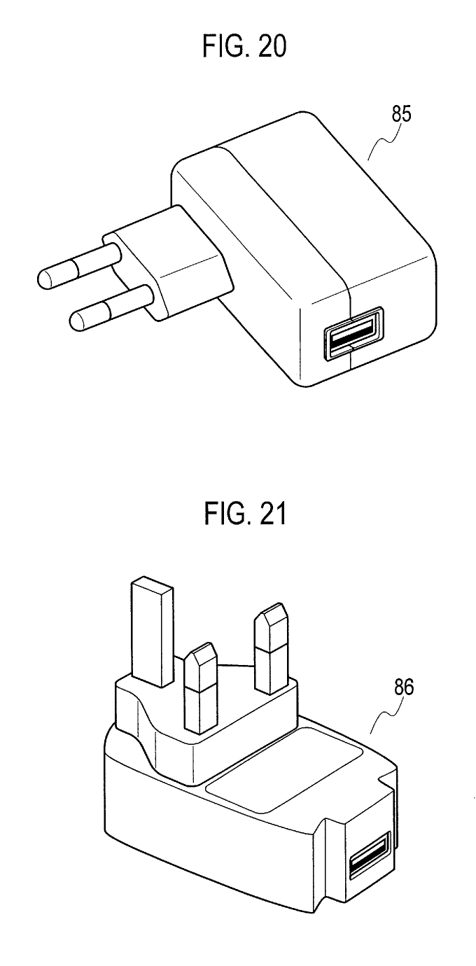

As shown in FIG. 20A, a plug 85 applicable to the adapter and the electronic apparatus mounted with the PD device (PD, USB PD) according to the first to eighth embodiments can be connected to the power socket having the AC power source, e.g., 100V-115V, and can also be USB-connected.

Moreover, as shown in FIG. 21, a plug 86 applicable to the adapter and the electronic apparatus mounted with the PD device (PD, USB PD) according to the first to eighth embodiments can be connected to the power socket having the AC power source, e.g., 230V, and can also be USB-connected.

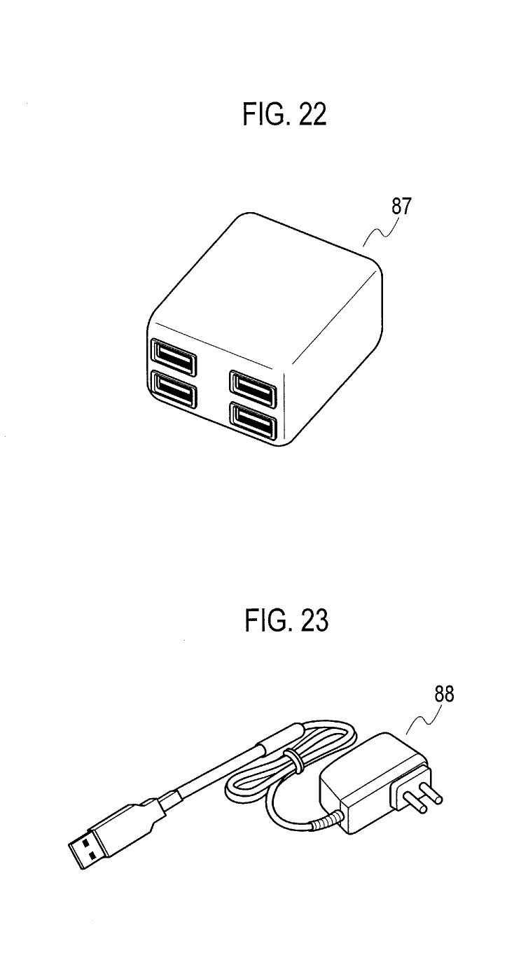

Moreover, as shown in FIG. 22, a plug 87 applicable to the adapter and the electronic apparatus mounted with the PD device (PD, USB PD) according to the first to eighth embodiments can be connected to the power socket having the AC power source, e.g., 100V-115V, and a plurality of the USB connections can also be achieved.

Moreover, as shown in FIG. 23, a plug 88 applicable to the adapter and the electronic apparatus mounted with the PD device (PD, USB PD) according to the first to eighth embodiments can be connected to the power socket having the AC power source, e.g., 100V-115V, and USB PD cable connection can also be achieved.

### (Power Delivery System)

In the PD system capable of applying the PD device according to the first to eighth embodiments, the source of electric power can be switched without changing a direction of the cable. For example, electric charging of a battery in a laptop PC from external devices and power transmission from the battery in the laptop PC to external devices (e.g., display etc.) can be achieved without replacement of the cable.

Moreover, a half-duplex data communication with AC superposition can be achieved between two units through the USB PD cable.

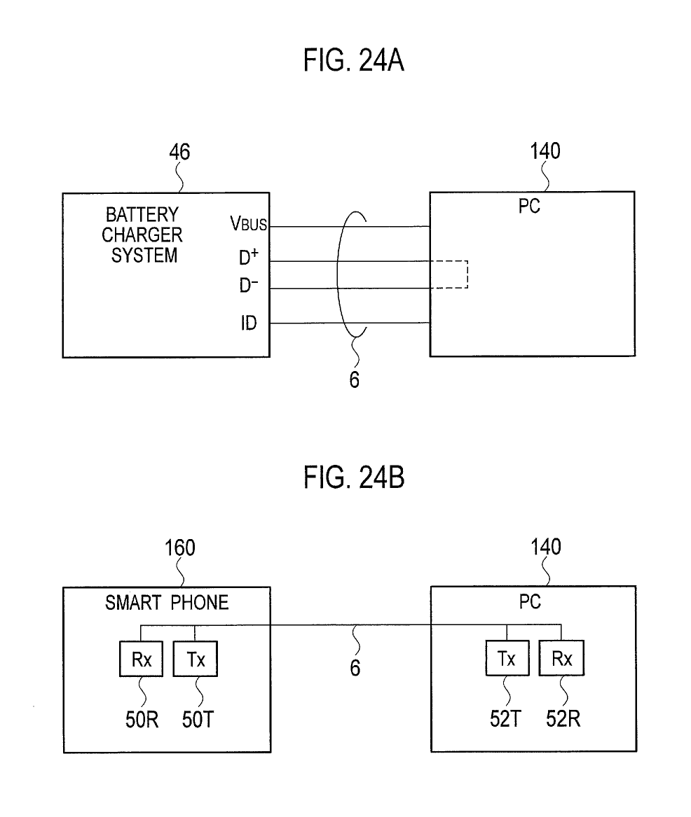

In the PD system capable of applying the PD device according to the first to eighth embodiments, DC power delivery (DC output V_{BUS}) and USB data communications (D⁺, D⁻, ID, etc.) can be achieved using the USB PD cable 6 between the battery charger system 46 and the laptop PC 140, as shown in FIG. 24A. In the present embodiment, although the PD device according to the first to eighth embodiments is mounted in the battery charger system 46 and the laptop PC 140, illustration thereof is omitted.

In the PD system capable of applying the PD device according to the first to eighth embodiments, the DC power delivery (DC output V_{BUS}) and the USB data communications (D⁺, D⁻, ID, etc.) can be transmitted also between the smart phone 160 and the laptop PC 140 using the USB PD cable 6, in the same manner as FIG. 24A. Furthermore, as shown in FIG. 24B, a transmitter (T_{X}) 50T and a receiver (R_{X}) 50R for USB data communications are mounted in the smart phone 160, and a transmitter (T_{X}) 52T and a receiver (R_{X}) 52R for USB data communications are mounted in the laptop PC 140. In the present embodiment, although the PD device according to the first to eighth embodiments is mounted in the smart phone 160 and the laptop PC 140, illustration thereof is omitted. The transmitter (T_{X}) 50T, 52T and the receiver (R_{X}) 50R, 52R for USB data communications are included in each secondary-side controller (PD CHIP) 16.

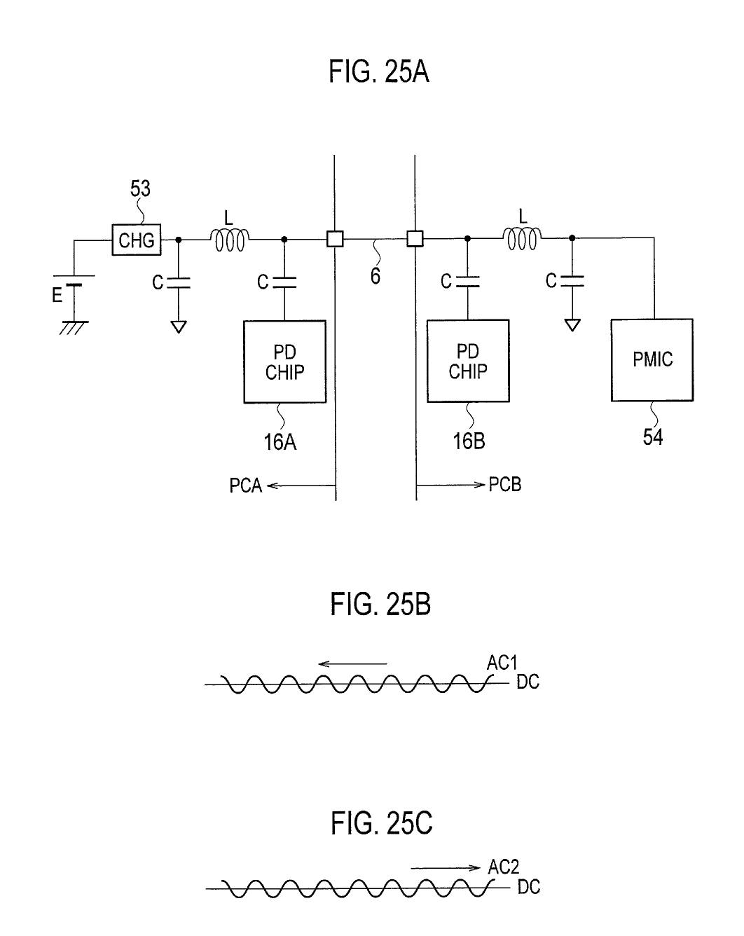

In the PD system capable of applying the PD device according to the first to eighth embodiments, FIG. 25A shows a schematic block configuration illustrating the USB data communication and the power delivery between two personal computers PCA, PCB, a waveform in which one-directional AC information AC1 superposed on the DC power is schematically illustrated as shown in FIG. 25B, and a waveform in which reverse directional AC information AC2 superposed on the DC power is schematically illustrated as shown in FIG. 25B. In the present embodiment, between the personal computers PCA, PCB is connected through the USB PD cable 6. Moreover, the PD device according to the first to eighth embodiments is mounted in each personal computer PCA, PCB. The illustration of the DC/DC converter is omitted, and the secondary-side controllers (PD CHIP) 16A, 16B are illustrated in FIG. 25A. As shown in FIG. 25A, a battery E and a battery charger IC (CHG) 53 connected to the battery E are mounted in the personal computer PCA, and a Power Management IC (PMIC) 54 is mounted in the personal computer PCA.

In the PD system capable of applying the PD device according to the first to eighth embodiments, for example, electric charging of the battery E from the personal computer PCB to the personal computer PCA, and power transmission of the battery E from the personal computer PCA to the personal computer PCB can achieved without replacement of any cable.

Moreover, the secondary-side controllers (PD CHIP) 16A, 16B are connected to the DC output V_{BUS} with AC coupling through the capacitor, and the half-duplex data communication with AC superposition is achieved in between the personal computers PCA, PCB. In the present embodiment, the carrier frequency is approximately 23.2 MHz, for example, and the FSK modulation/demodulation frequency is approximately 300 kbps, for example. In the present embodiment, the Bit Error Rate (BER) is approximately 1×10⁻⁶, and an LSI for built-in self tests (BIST) may be included therein, for example.

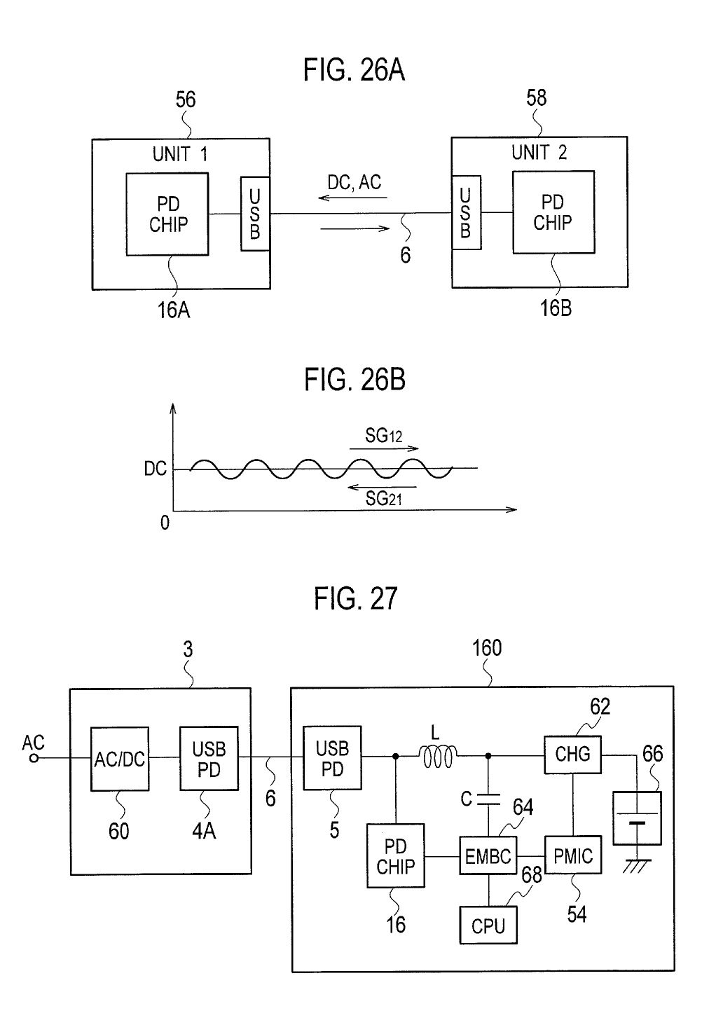

In the PD system capable of applying the PD device according to the first to eighth embodiments, FIG. 26A shows a schematic block configuration illustrating the USB data communication and the power delivery between two units 56, 58, and waveform in which the control signals SG₁₂, SG₂₁ to be bidirectionally transmitted are superposed on the DC power is schematically illustrated as shown in FIG. 26B. The two units 56, 58 are connected to each other through the USB PD cable 6. The two units 56, 58 may be arbitrary electronic apparatus, and the PD device according to the first to eighth embodiments is mounted therein. The illustration of the DC/DC converter is omitted, and the secondary-side controllers (PD CHIP) 16A, 16B are illustrated in FIG. 26A.

FIG. 27 shows a schematic block configuration in which the smart phone 160 is connected to the AC adapter 3 through the USB PD cable 6, in the PD system capable of applying the PD device according to the first to eighth embodiments.

The AC adapter 3 includes an AC/DC converter 60 and a USB PD 4A. The smart phone 160 includes a USB PD 5, a secondary-side controller (PD CHIP) 16, an embedded type controller (EMBC) (EMBC) 64, a CPU 68, a PMIC 54, a battery 66, and a CHG 62.

In the PD system capable of applying the PD device according to the first to eighth embodiments, electric charging of the battery 66 in the smart phone 160 from the AC adapter 3, and power transmission to the external device from the battery 66 in the smart phone 160 can be achieved without replacement of the cable, for example.

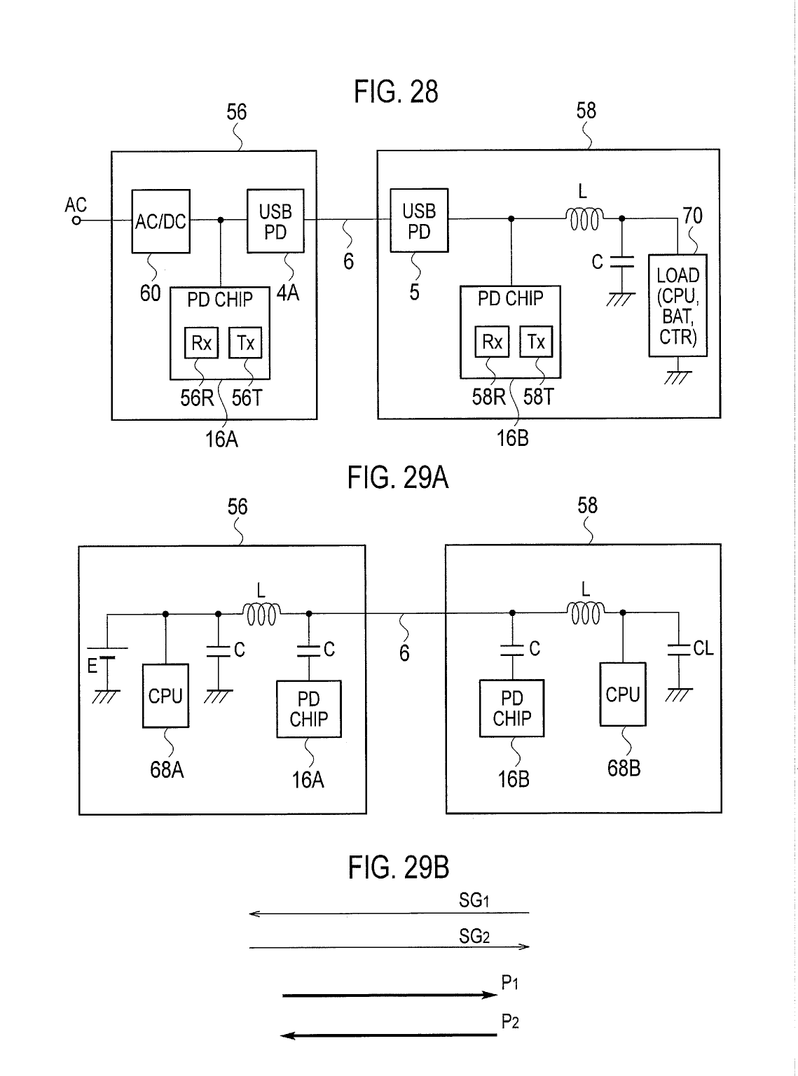

FIG. 28 shows a schematic block configuration in which the unit 56 and the unit 58 are connected to each other through the USB PD cable 6, in the PD system capable of applying the PD device according to the first to eighth embodiments.

The unit 56 includes an AC/DC converter 60, a USB PD device 4A, and a secondary-side controller (PD CHIP) 16A, and the unit 58 includes a USB PD device 5, a secondary-side controller (PD CHIP) 16B, and a load 70. In the present embodiment, the load 70 can be composed of a CPU, a battery BAT, a controller CTR, etc.

Furthermore, as shown in FIG. 28, a transmitter (T_{X}) 56T for USB data communications and a receiver (R_{X}) 56R are mounted in the secondary-side controller (PD CHIP) 16A, and a transmitter (T_{X}) 56T for USB data communications and a receiver (R_{X}) 56R are mounted in the secondary-side controller (PD CHIP) 16B.

In the PD system capable of applying the PD device according to the first to eighth embodiments, power transmission from the unit 56 to the unit 58, and power transmission to external devices from the unit 58 can be achieved without replacement of the cable, for example.

Moreover, the half-duplex data communication with AC superposition is achieved also in between the units 56, 58 through the USB PD cable 6.

In the PD system capable of applying the PD device according to the first to eighth embodiments, FIG. 29A shows a schematic block configuration composed of two units 56, 58 different from the configuration shown in FIG. 28, and FIG. 29B shows a schematic diagram illustrating a transmission direction of the USB data and electric power transmitted through the USB PD cable 6.

The unit 56 includes a battery E, a CPU 68A and a secondary-side controller (PD CHIP) 16A, and the unit 58 includes a secondary-side controller (PD CHIP) 16B and a load CL.

In the PD system capable of applying the PD device according to the first to eighth embodiments, power transmission from the unit 58 to the unit 56, and power transmission to the unit 58 from the battery E can be achieved without replacement of the cable, for example.

Moreover, the half-duplex data communication with AC superposition is achieved also in between the units 56, 58 through the USB PD cable 6.

### (Power Delivery System)

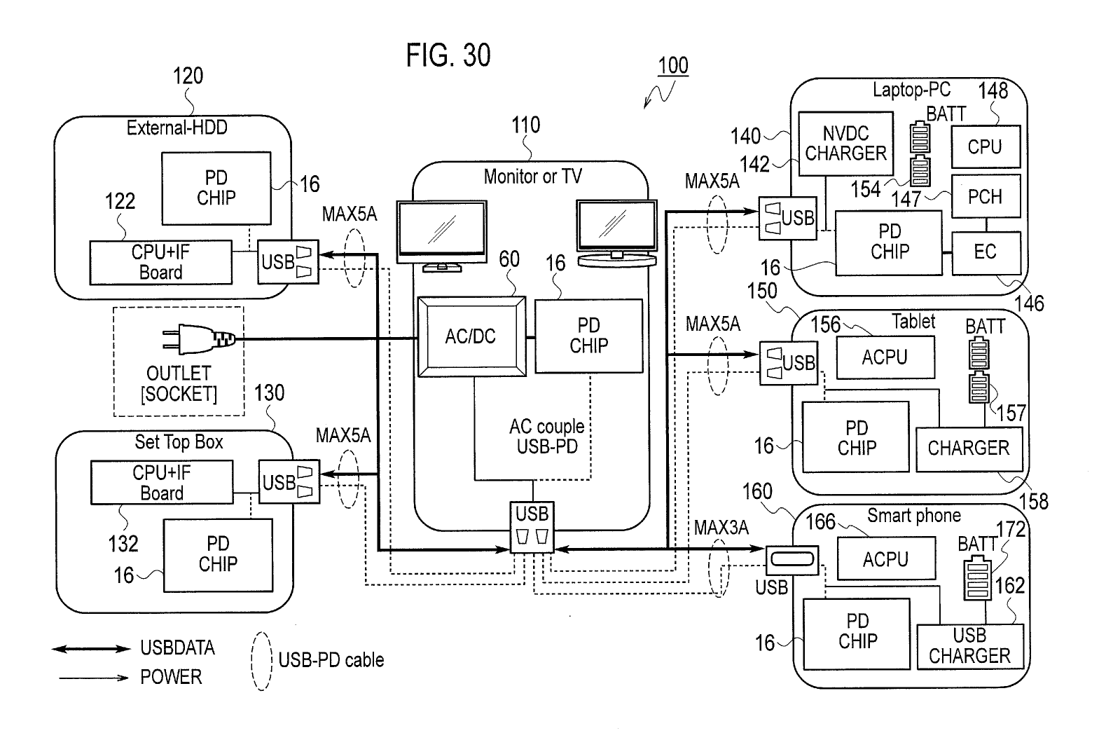

As shown in FIG. 30, a first PD system 100 capable of applying the PD device (PD, USB PD) according to the first to eighth embodiments includes: a monitor 110 connected to a power socket through a plug; and an external hard disk drive 120/a set top box 130/a laptop PC 140/a tablet PC 150/a smart phone 160, each of which is connected to the monitor 110 using the USB PD cable.

Although the PD device (PD, USB PD) according to the first to eighth embodiments 4A is mounted in each configuring elements, the illustration of the DC/DC converter is omitted in FIG. 30, but the secondary-side controller (PD CHIP) 16 is illustrated in FIG. 30.

USB DATA and DC power can be transmitted between the monitor 110 and the external hard disk drive 120/set top box 130/laptop PC 140/tablet PC 150/smart phone 160 through the USB PD cable.

An AC/DC converter 60 is mounted in the monitor 110. A CPU/interface board 122 is mounted in the external hard disk drive 120. A CPU/interface board 132 is mounted in the set top box 130. A Narrow Voltage DC/DC (NVDC) charger 142, a CPU 148, a Platform Controller Hub (PCH) 147, and an Embedded Controller (EC) 146 are mounted in the laptop PC 140. An Application CPU (ACPU) 156, a charger 158, and a battery 157 are mounted in the tablet PC 150. An ACPU 166, a USB charger 162, and a battery 172 are mounted in a smart phone 160.

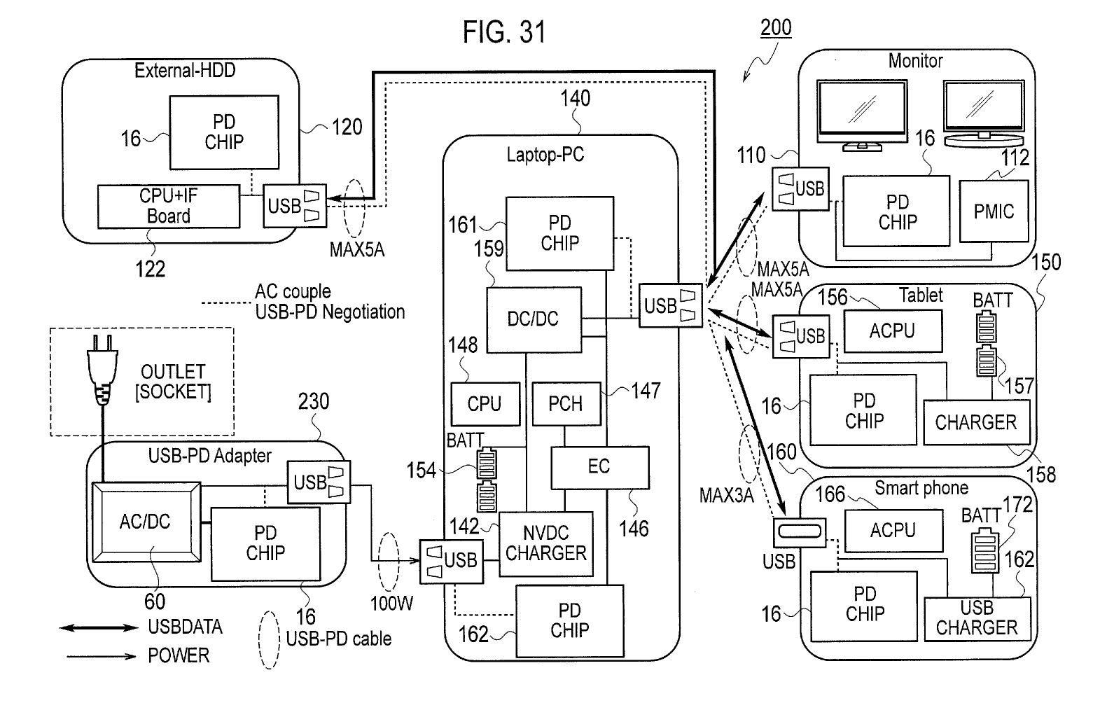

As shown in FIG. 31, a second PD system 200 capable of applying the PD device (PD, USB PD) according to the first to eighth embodiments includes: a USB PD adapter 230 connected to a power socket through a plug; a laptop PC 140 connected to the USB PD adapter 230 using the USB PD cable; and an external hard disk drive 120/monitor 110/tablet PC 150/smart phone 160 connected to the laptop PC 140 using the USB PD cable.

Although the PD device (PD, USB PD) according to the first to eighth embodiments 4A is mounted in each configuring elements, the illustration of the DC/DC converter is omitted in FIG. 31, but the secondary-side controller (PD CHIP) 16 is illustrated in FIG. 31.

The USB DATA and the DC power can be transmitted between the laptop PC 140 and the external hard disk drive 120/monitor 110/tablet PC 150/smart phone 160 through the USB PD cable.

An NVDC charger 142, a CPU 148, a PCH 147, a EC 146, a battery 154, a DC/DC converter 159, and PD CHIPs 16₁, 16₂ are mounted in the laptop PC 140. A Power Management IC (PMIC) 112 is mounted in the monitor 110. Other configurations are the same as that of the first PD system 100 (FIG. 30).

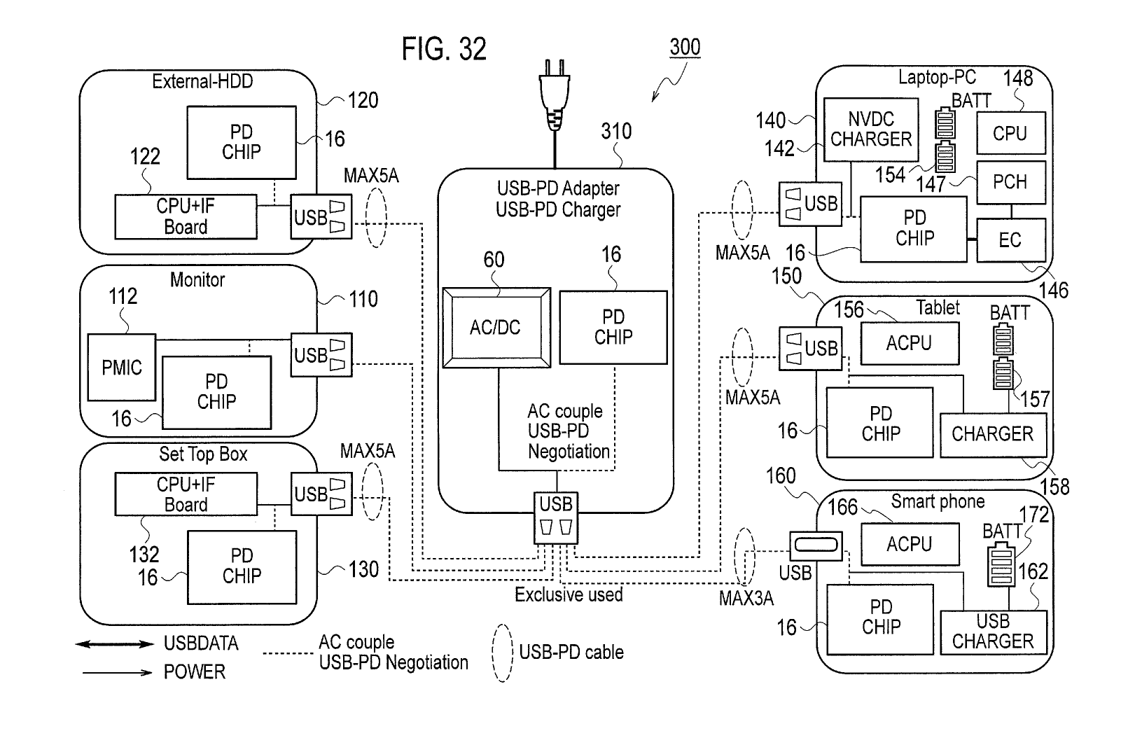

As shown in FIG. 32, a third PD system 300 capable of applying the PD device (PD, USB PD) according to the first to eighth embodiments includes: a USB PD adapter (USB PD charger) 310 connected to a power socket through a plug; and an external hard disk drive 120/a monitor 110/a set top box 130/a laptop PC 140/a tablet PC 150/a smart phone 160 each connected to the USB PD adapter (USB PD charger) 310 using the USB PD cable.

Although the PD device (PD, USB PD) according to the first to eighth embodiments 4A is mounted in each configuring elements, the illustration of the DC/DC converter is omitted in FIG. 32, but the secondary-side controller (PD CHIP) 16 is illustrated in FIG. 32.

The USB DATA and the DC power can be transmitted between the USB PD adapter 310 (USB PD charger) and the external hard disk drive 120/the monitor 110/the set top box 130/the laptop PC 140/the tablet PC 150/the smart phone 160 through the USB PD cable.

The AC/DC converter 60 is mounted in the USB PD adapter (USB PD charger) 310. Other configurations are the same as that of the first PD system 100 (FIG. 30) and the second PD system 200 (FIG. 31).

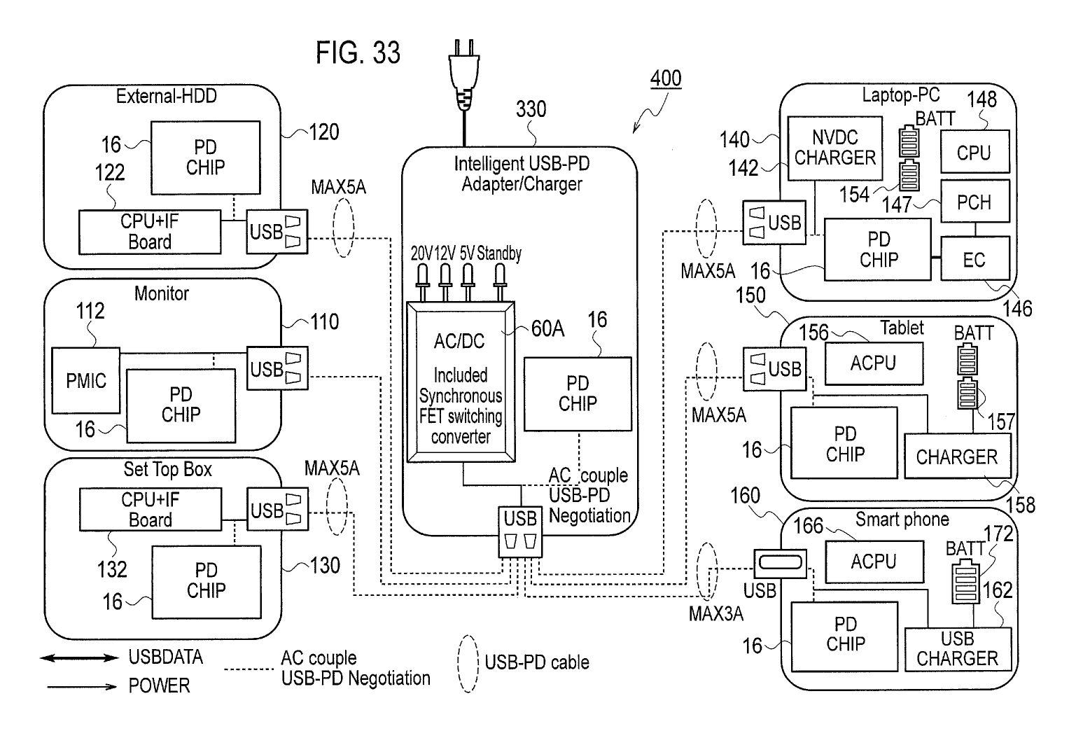

As shown in FIG. 33, a fourth PD system 400 capable of applying the PD device (PD, USB PD) according to the first to eighth embodiments includes: a high-performance USB PD adapter/charger 330 connected to a power socket through a plug; and an external hard disk drive 120/a monitor 110/a set top box 130/a laptop PC 140/a tablet PC 150/a smart phone 160 each connected to the high-performance USB PD adapter/charger 330 using the USB PD cable.

Although the PD device (PD, USB PD) according to the first to sixth embodiments 4A is mounted in each configuring elements, the illustration of the DC/DC converter is omitted in FIG. 32, but the secondary-side controller (PD CHIP) 16 is illustrated in FIG. 32.

The USB DATA and the DC power can be transmitted between the high-performance USB PD adapter/charger 330 and the external hard disk drive 120/the monitor 110/the set top box 130/the laptop PC 140/the tablet PC 150/the smart phone 160 through the USB PD cable. The AC/DC converter 60A including a synchronous FET switching converter is mounted in the high-performance USB PD adapter/charger 330. Other configurations are the same as that of the third PD system 300 (FIG. 32).

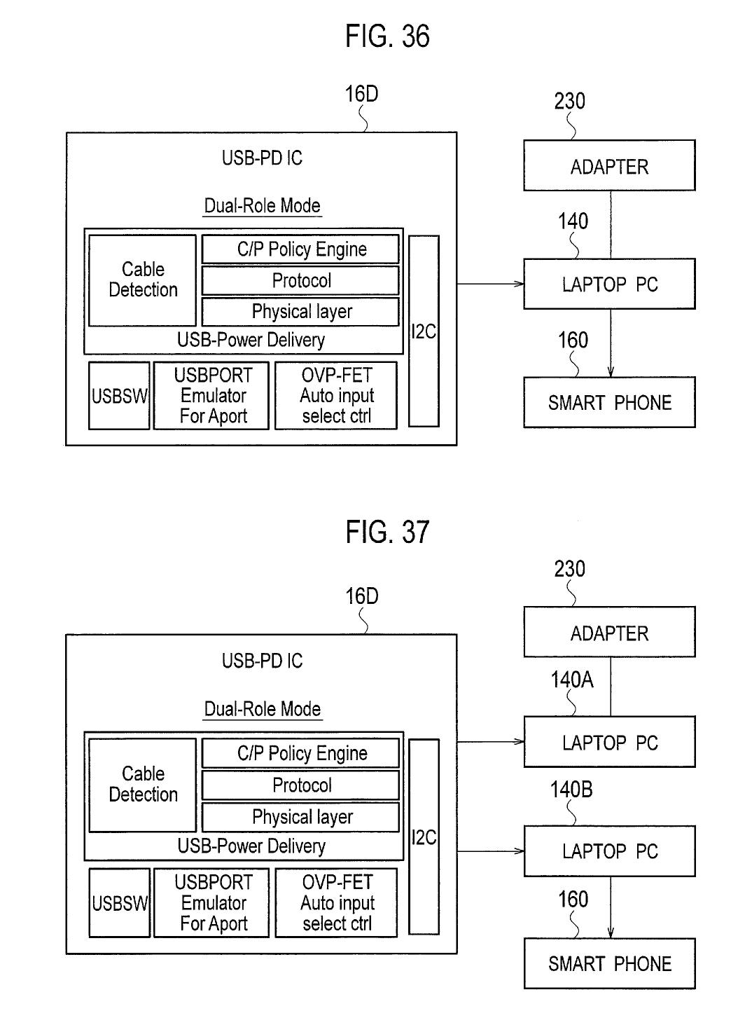

A usage example of the secondary-side controller (PD CHIP) applicable to the PD device according to the first to eighth embodiments is illustrated as shown in FIGS. 36, 37 and 38.

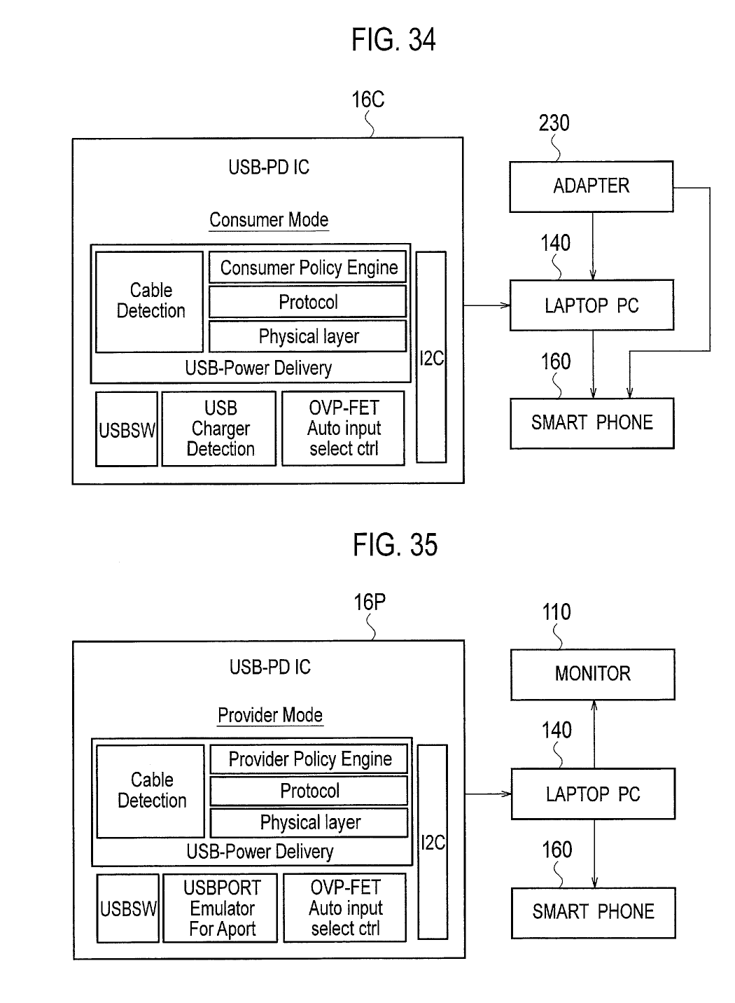

The PD CHIP 16C applicable in a consumer mode for receiving the power delivery from connecting target devices (sets) is connected to the laptop PC 140 connected to the AC adapter 230, as shown in FIG. 34. The laptop PC 140 can be further connected to the smart phone 160, and the smart phone 160 can also be connected to the AC adapter 230.

The PD CHIP 16P applicable in a provider mode for delivering (providing) electric power to the connecting target devices (sets) is connected to the laptop PC 140, as shown in FIG. 35. The laptop PC 140 can be further connected to the monitor 110 and the smart phone 160.

The PD CHIP 16D applicable in a dual role mode of both of the consumer mode and the provider mode is connected to the laptop PC 140 connected to the AC adapter 230, as shown in FIG. 36. The laptop PC 140 can be further connected to the smart phone 160.

The PD CHIP 16D applicable in the dual role mode can be connected to the laptop PC 140A connected to connected to the AC adapter 230, and can be further connected to the laptop PC 140B connected to the smart phone 160, as shown in FIG. 37.

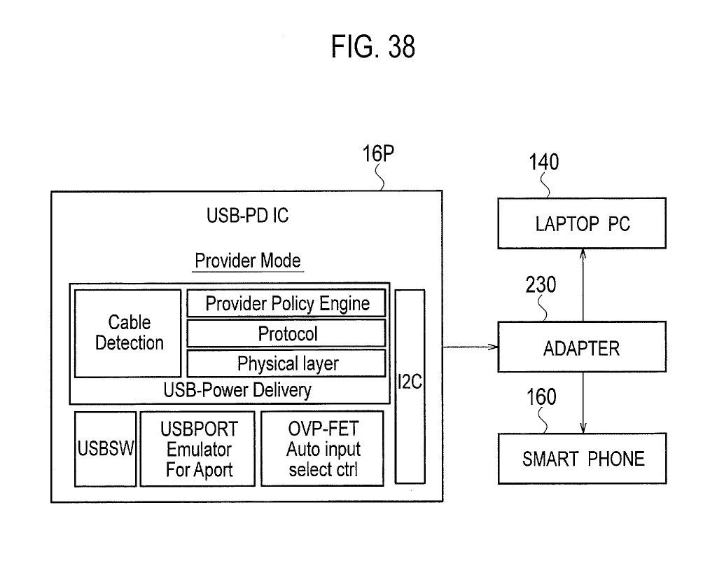

As shown in FIG. 38, the PD CHIP 16P applicable in the provider mode for delivering (providing) electric power to the connecting target devices (sets) may be connected to the AC adapter 230, and the AC adapter 230 may be connected to the laptop PC 140 and the smart phone 160.

As mentioned above, according to the present invention, there can be provided the PD device, the start-up method for such a PD device, the AC adapter, and the electronic apparatus, each of which can control the output voltage value and the available output current capacity (MAX value).

### OTHER EMBODIMENTS

While the solution testing equipments are described in accordance with the embodiments, it should be understood that the description and drawings that configure part of this disclosure are merely instances, and are not intended to limit the present invention. This disclosure makes clear a variety of alternative embodiments, working examples, and operational techniques for those skilled in the art.

Such being the case, the present invention covers a variety of embodiments, whether described or not.

What is claimed is:

1. A power delivery device comprising:
a DC/DC converter disposed between an input and an output;
a primary-side controller configured to start up the DC/DC converter; and
a secondary-side controller connected to an output of the DC/DC converter, the secondary-side controller AC-coupled to the output, the secondary-side controller configured to feed back electric power information of the output to the primary-side controller and an input of the DC/DC converter, wherein
the secondary-side controller controls an input current of the DC/DC converter, thereby varying an output voltage value and an available output current capacity of the DC/DC converter.

2. The power delivery device according to claim 1 further comprising:
an insulation circuit connected to the secondary-side controller, the insulation circuit configured to feed back the electric power information of the output to the primary-side controller.

3. The power delivery device according to claim 2, wherein the DC/DC converter is a diode rectification converter.

4. The power delivery device according to claim 3, wherein the DC/DC converter comprising:
a transformer;
a first MOS transistor connected between the primary-side inductance of the transformer, and a ground potential;
a diode connected between the secondary-side inductance of the transformer, and the output; and
a first capacitor connected between the output and the ground potential, wherein
the secondary-side controller can input a driving control signal into a gate of the first MOS transistor through the insulation circuit.

5. The power delivery device according to claim 2, wherein the DC/DC converter is a synchronous rectification converter.

6. The power delivery device according to claim 5, wherein the DC/DC converter comprising:
a transformer;
a first MOS transistor connected between the primary-side inductance of the transformer, and a ground potential;
a second MOS transistor connected between the secondary-side inductance of the transformer, and the output; and
a first capacitor connected between the output and the ground potential, wherein
the secondary-side controller can input a driving control signal into a gate of the first MOS transistor through the insulation circuit.

7. The power delivery device according to claim 6, further comprising:
a current sensing resistor connected between the secondary-side inductance of the transformer and a ground potential.

8. The power delivery device according to claim 7, wherein the secondary-side controller can detect an amount of current conducted to the secondary-side inductance of the transformer through the current sensing resistor.

9. The power delivery device according to claim 1 further comprising:
a current sensing resistor connected between the output of the DC/DC converter, and the output.

10. The power delivery device according to claim 9, wherein the secondary-side controller can detect an amount of current conducted between the output of the DC/DC converter and the output through the current sensing resistor.

11. The power delivery device according to claim 1, wherein the secondary-side controller detects and monitors the output voltage from the DC/DC converter 13 through the connection line between the output of the DC/DC converter 13 and the secondary-side controller.

12. The power delivery device according to claim 11, wherein the output voltage of the DC/DC converter can also double as a power source of the secondary-side controller.

13. The power delivery device according to claim 1, wherein the electric power information includes DC information in the output, and AC information input into the output from an outside, the AC information being AC-superposed on the DC information.

14. The power delivery device according to claim 4, wherein
the secondary-side controller comprises a PWM control circuit, wherein
the PWM control circuit can output about the driving control signal.

15. The power delivery device according to claim 1 further comprising:
an AC input; and
an AC/DC converter connected between the AC input and an input of the DC/DC converter.

16. The power delivery device according to claim 1 further comprising:
a second DC/DC converter connected to the DC/DC converter, wherein
the secondary-side controller is built in the second DC/DC converter.

17. The power delivery device according to claim 16, wherein the second DC/DC converter comprises a third MOS transistor controlled by the secondary-side controller.

18. An AC adapter comprising a power delivery device, the power delivery device comprising:
a DC/DC converter disposed between an input and an output;
a primary-side controller configured to start up the DC/DC converter; and
a secondary-side controller connected to an output of the DC/DC converter, the secondary-side controller AC-coupled to the output, the secondary-side controller configured to feed back electric power information of the output to the primary-side controller and an input of the DC/DC converter, wherein
the secondary-side controller controls an input current of the DC/DC converter, thereby varying an output voltage value and an available output current capacity of the DC/DC converter.

19. An electronic apparatus comprising a power delivery device, the power delivery device comprising:
a DC/DC converter disposed between an input and an output;
a primary-side controller configured to start up the DC/DC converter; and
a secondary-side controller connected to an output of the DC/DC converter, the secondary-side controller AC-coupled to the output, the secondary-side controller configured to feed back electric power information of the output to the primary-side controller and an input of the DC/DC converter, wherein
the secondary-side controller controls an input current of the DC/DC converter, thereby varying an output voltage value and an available output current capacity of the DC/DC converter.

20. A start-up method of a power delivery device, wherein the power delivery device comprises:
a DC/DC converter disposed between an input and an output;
a primary-side controller configured to start up the DC/DC converter; and
a secondary-side controller connected to an output of the DC/DC converter, the secondary-side controller configured to feed back electric power information of the output to the primary-side controller and an input of the DC/DC converter, wherein the method comprising:
at first timing, starting up the primary-side controller; and
at second timing, after an output voltage of the DC/DC converter reaches a constant level, turning off the primary-side controller, and turning on the secondary-side controller, thereby switching to control by the secondary-side controller.
